(19) United States
(12) Patent Application Publication
(10) Pub. No.: US 2026/0342441 A1
(43) Pub. Date: Oct. 29, 2026

(54) SYSTEM AND METHODS FOR PASSIVELY SENSING OPTICAL SIGNALS AT A FIBER TERMINATION

(71) Applicant: AT&T Intellectual Property I, L.P., Atlanta, GA (US)

(72) Inventors: Ricky A. Perry, Cumming, GA (US); Kirk D. Drane, McKinney, TX (US); Stewart Edward Barker, Lucas, TX (US); Shawn Turner, Burleson, TX (US)

(73) Assignee: AT&T Intellectual Property I, L.P., Atlanta, GA (US)

(21) Appl. No.: 19/193,435

(22) Filed: Apr. 29, 2025

(51) Int. Cl. H04B 10/27; G01N 21/64; H04B 10/60

(52) U.S. Cl. CPC H04B 10/27; G01N 21/6447; H04B 10/60; G01N 2201/088

(57) ABSTRACT

Aspects of the subject disclosure may include, for example, a passive fiberoptic signal sensing device configured for visually detecting physical properties of fiberoptic transmission signals without external diagnostic equipment. The device includes a housing and an integrated optical sensing assembly including a photosensitive screen and a beam spreading element. The screen, coated with photosensitive material, undergoes visible changes—such as varying shades or colors—based on signal intensity or wavelength. A beam spreading element disperses the signal over the screen, enabling visual indication of signal presence and quality. The device can be installed in a wall jack for customer self-installation of broadband services, facilitating troubleshooting and reducing technician visits. The method involves positioning the screen along an optical axis, selectively occluding signal propagation, and spreading the signal to provide visual feedback. Applications include broadband service installations and network maintenance, enhancing user accessibility and operational efficiency. Other embodiments are disclosed.

### FIELD OF THE DISCLOSURE

The subject disclosure relates to system and methods for passively sensing optical signals at a fiber termination.

### BACKGROUND

Fiber optic communication systems play a significant role in modern broadband networks, serving a wide array of commercial, residential, and industrial applications. These systems rely on intricate arrangements of fiber cables and optical components to transmit data efficiently over long distances. Operators continually aim to maintain high levels of network reliability and performance, which necessitate accurate methods for verifying signal transmission. In current deployments, ensuring that optical fibers operate as intended is essential for achieving rapid service turn-up and effective network maintenance. In this context, various methods have been employed to assess the functional quality of optical connections and signal paths, establishing a basis for further enhancements in system diagnostics and maintenance.

Broadband service installations increasingly emphasize customer self-installation models that reduce reliance on technical support personnel. Operators seek to streamline these processes by providing solutions that allow users to quickly and easily assess the operational status of their network connections. Achieving efficient, user-friendly setups directly translates to faster service activation and reduced operational expenses. In this pursuit, there is a strong focus on devising methods that facilitate straightforward verification of optical connectivity during installation. The goal is to improve customer satisfaction and optimize network performance without compromising the overall safety and reliability of the system.

Notwithstanding advancements in optical technologies, there persists a notable challenge in simplifying the evaluation of optical signal integrity for installers lacking specialized training. Conventional validation techniques typically depend on the use of precision instruments and technical intervention, which can lead to service delays and increased costs. The inability to immediately and visibly ascertain whether optical signals are present at important connection points burdens both customers and support teams. This gap underscores the need for methods that can offer clear, accessible indicators of signal status, thereby reducing the frequency of unnecessary service visits and expediting troubleshooting efforts.

In numerous customer self-installation scenarios, the process for verifying the presence and quality of an optical transmission signal remains cumbersome. Current approaches necessitate the use of external diagnostic tools to measure signal strength and presence, leading to dependency on technicians and specialized equipment. This reliance creates inefficiencies and may contribute to extended service outages when issues arise, complicating the task of promptly identifying whether a problem originates in the customer premises or elsewhere in the network. Addressing this specific challenge is crucial for enhancing operational efficiency, reducing support costs, and ensuring that network installations meet the desired performance and reliability standards.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications system adapted for passively sensing optical signals at a fiber termination in accordance with various aspects described herein.

FIG. 2A is a block diagram illustrating an example, non-limiting embodiment of an optical distribution network adapted for passively sensing optical signals at a fiber termination and functioning within the communication system of FIG. 1 in accordance with various aspects described herein.

FIG. 2B is a block diagram illustrating an example, non-limiting embodiment of a jack housing assembly functioning within the optical distribution network of FIG. 2A and the communication system of FIG. 1 in accordance with various aspects described herein.

FIG. 2C is a block diagram illustrating another example, non-limiting embodiment of a jack housing assembly functioning within the optical distribution network of FIG. 2A and the communication system of FIG. 1 in accordance with various aspects described herein.

FIG. 2D is a block diagram illustrating an example, non-limiting embodiment of a passive, optical sensing assembly functioning within the optical distribution network of FIG. 2A and the communication system of FIG. 1 in accordance with various aspects described herein.

FIG. 2E is a block diagram illustrating an example, non-limiting embodiment of a passive optical sensor functioning within the jack housing assemblies of FIGS. 2B, 2C and the optical sensing assembly of FIG. 2D in accordance with various aspects described herein.

FIG. 2F is a block diagram illustrating another example, non-limiting embodiment of a passive optical sensor functioning within the jack housing assemblies of FIGS. 2B, 2C and the optical sensing assembly of FIG. 2D in accordance with various aspects described herein.

FIG. 2G is a block diagram illustrating yet another example, non-limiting embodiment of a passive optical sensor functioning within the jack housing assemblies of FIGS. 2B, 2C and the optical sensing assembly of FIG. 2D in accordance with various aspects described herein.

FIG. 2H is a block diagram illustrating an example, non-limiting embodiment of a passive, optical sensing, fiber termination assembly functioning within the optical distribution network of FIG. 2A and the communication system of FIG. 1 in accordance with various aspects described herein.

FIG. 2I is a block diagram illustrating another example, non-limiting embodiment of a passive, optical sensing, fiber termination assembly functioning within the optical distribution network of FIG. 2A and the communication system of FIG. 1 in accordance with various aspects described herein.

FIG. 2J is a block diagram illustrating yet another example, non-limiting embodiment of a passive-sensing fiberoptic termination assembly, shown in an engaged configuration and functioning within the optical distribution network of FIG. 2A and the communication system of FIG. 1 in accordance with various aspects described herein.

FIG. 2K is a block diagram illustrating yet another example, non-limiting embodiment of a passive-sensing fiberoptic termination assembly, shown in a disengaged configuration and functioning within the optical distribution network of FIG. 2A and the communication system of FIG. 1 in accordance with various aspects described herein.

FIG. 2L is a block diagram illustrating another example, non-limiting embodiment of an optical distribution network adapted for passively sensing optical signals at a fiber termination and functioning within the communication system of FIG. 1 in accordance with various aspects described herein.

FIG. 3A depicts an illustrative embodiment of a process adapted for passively sensing optical signals at a fiber termination in accordance with various aspects described herein.

FIG. 3B depicts another illustrative embodiment of a process adapted for passively sensing optical signals at a fiber termination in accordance with various aspects described herein.

FIG. 4 is a block diagram illustrating an example, non-limiting embodiment of a virtualized communication network in accordance with various aspects described herein.

FIG. 5 is a block diagram of an example, non-limiting embodiment of a computing environment in accordance with various aspects described herein.

FIG. 6 is a block diagram of an example, non-limiting embodiment of a mobile network platform in accordance with various aspects described herein.

FIG. 7 is a block diagram of an example, non-limiting embodiment of a communication device in accordance with various aspects described herein.

### DETAILED DESCRIPTION

The subject disclosure describes, among other things, illustrative embodiments for a passive fiberoptic signal sensing device and methods that use a photosensitive material to visually indicate the presence, intensity, and/or wavelength of optical signals, enabling efficient troubleshooting and customer self-installation of broadband services, while also offering protection from exposure to fiberoptic transmission signals. Other embodiments are described in the subject disclosure.

One or more aspects of the subject disclosure include a passive fiberoptic signal sensing device including a housing and an integrated optical sensing assembly disposed within the housing. The optical sensing assembly includes a photosensitive screen formed of a material that undergoes a visible change upon absorbing light, the change corresponding to a physical property of a fiberoptic transmission signal, and a beam spreading element that disperses the signal over a predetermined area of the screen. In various embodiments, the photosensitive material is configured to detect ultraviolet, visible, near-infrared, or mid-infrared wavelengths, and the physical property may pertain to signal intensity—causing the screen to display varying shades—or to wavelength—with the screen exhibiting different colors. Additional embodiments may include features such as a protective cover for the screen, a symbolic representation (for example, a plurality of stripes responsive to different wavelengths), and a slow-fading material that maintains the visible indication. The housing may also be adapted for installation in a wall jack to facilitate customer self-installation of broadband services while providing visual troubleshooting of signal presence and intensity.

One or more aspects of the subject disclosure include a method for passively sensing a fiberoptic signal. The method involves positioning a screen that is movable between an open position and a closed position along an optical axis, with the closed position substantially occluding the passage of the fiberoptic signal. At least a portion of the screen is covered with a photosensitive material configured to undergo a visible change in response to light absorption, thus reflecting a physical property of the fiberoptic transmission signal. A beam spreading element is positioned between an optical fiber and the screen to disperse the signal over a predetermined area, enabling the screen to provide a visual indication of the physical property—such as displaying different shades for varying intensities or different colors for distinct wavelengths—without the need for external diagnostic equipment. In some embodiments, the dispersion of the signal involves either refracting or diffusing the fiberoptic signal, and the screen may be situated to cover a wall jack receptacle, further enhancing the method's utility in self-installation scenarios.

One or more aspects of the subject disclosure include selectively occluding propagation of a fiberoptic transmission signal residing within an invisible wavelength region by positioning a photosensitive screen moveable between open and closed positions. With the screen in the closed position, the fiberoptic signal is spread over a predetermined area of the screen, where a portion of the signal in the invisible region is absorbed. In response, the screen emits a visual indication corresponding to the absorbed signal, thereby providing an observable indication of the signal's physical property without relying on external diagnostic equipment.

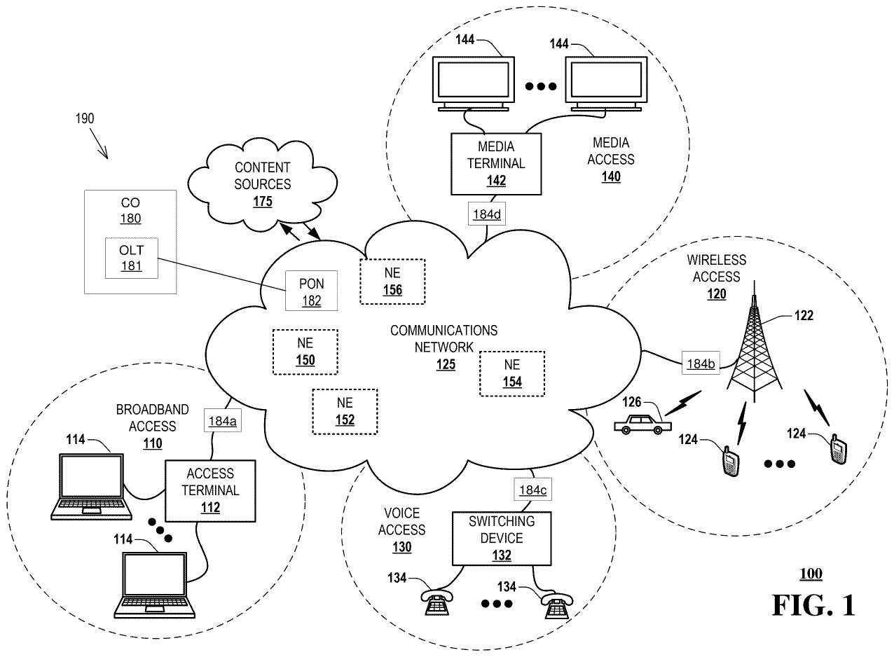

Referring now to FIG. 1, a block diagram is shown illustrating an example, non-limiting embodiment of a communication system 100 in accordance with various aspects described herein. For example, the communication system 100 can facilitate in whole or in part a passive fiberoptic signal sensing device and methods that use a photosensitive material to visually indicate the presence, intensity, and/or wavelength of optical signals, enabling efficient troubleshooting and customer self-installation of broadband services, while also offering protection from exposure to fiberoptic transmission signals. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc., can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

In at least some embodiments, the communication system 100 includes an optical distribution network 190, e.g., extending from a central office (CO) 180 to customer premises served by one or more of the various access networks 110, 120, 130, 140. For example, the CO 180 may contain an optical source, such as an example optical line terminal (OLT) 181. The OLT 181 can be coupled to demarcation terminals at customer premises served by one or more of the various access networks 110, 120, 130, 140, such as the example fiber jacks 184a through 184d, generally 184. In at least some embodiments, a passive optical network (PON) provides optical channels, e.g., optical fibers, couplers, splitters and so on, to optically couple the fiber jacks 184 to the OLT 181.

It is understood that during normal operations, laser light injected into the PON 182 by an optical transmitter of the OLT 181 will be distributed to all of the interconnected fiber jacks 184, regardless of whether a service has been activated at a particular premises. It is also recognized that such laser light may pose a hazard to human tissue, such as a human eye, e.g., a lens, cornea and/or retina. Accordingly, the fiber jacks 184 can be configured with shields that block and/or otherwise occlude any laser light carried by the PON 182 from exiting the fiber jacks 184, especially when the fiber jacks 184 are disconnected from any cabling and/or devices. According to the illustrative embodiments presented herein, the fiber jacks 184 and/or the provided shields provided thereon, may be configured to provide a visual indication responsive to presence of laser light as may be delivered by the PON 182. It is understood that circumstances may result in an unintended interruption to delivery of PON service to a particular fiber jack 184 as may result from a broken cable, and/or a disconnection somewhere within the PON 182 and/or within local fiber routing within the customer premises. Beneficially, the visual indication may be used by an end user or consumer to identify whether optical signal is present at a particular jack 184 without requiring special test equipment and/or without requiring local assistance of a trained technician. For example, the end user may relay a visual indication status to a helpdesk and/or self-help program to facilitate diagnostic procedures to detect, locate and/or remedy any defects.

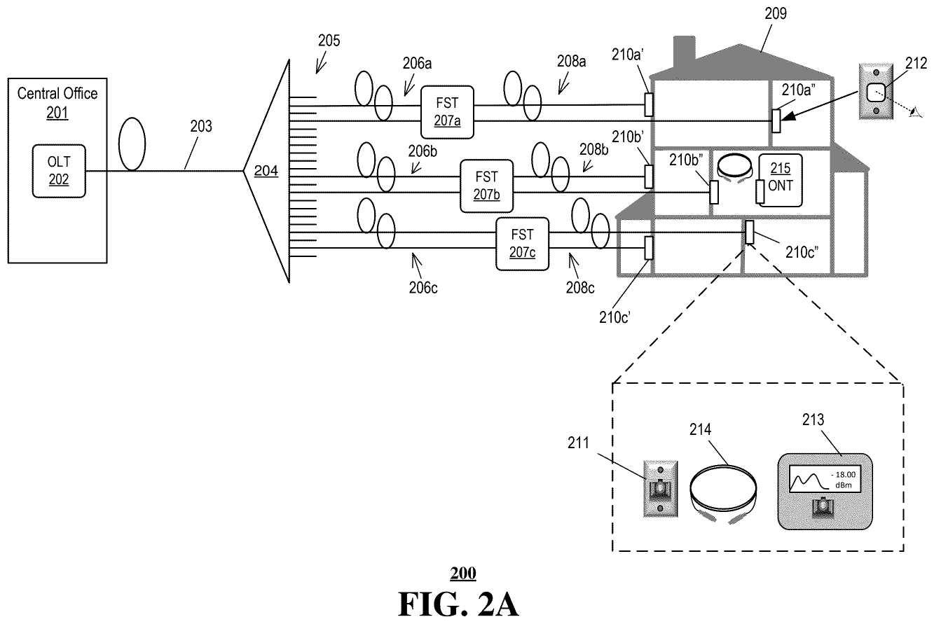

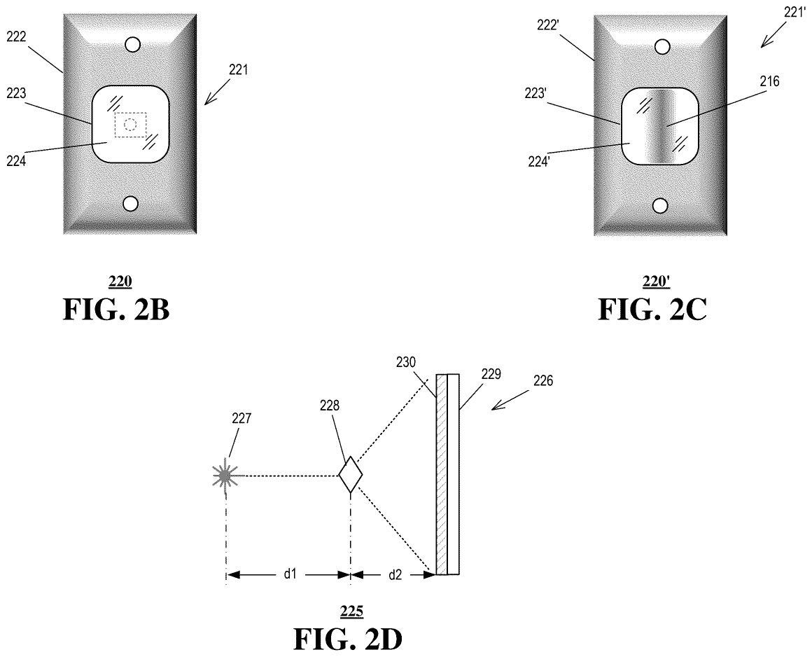

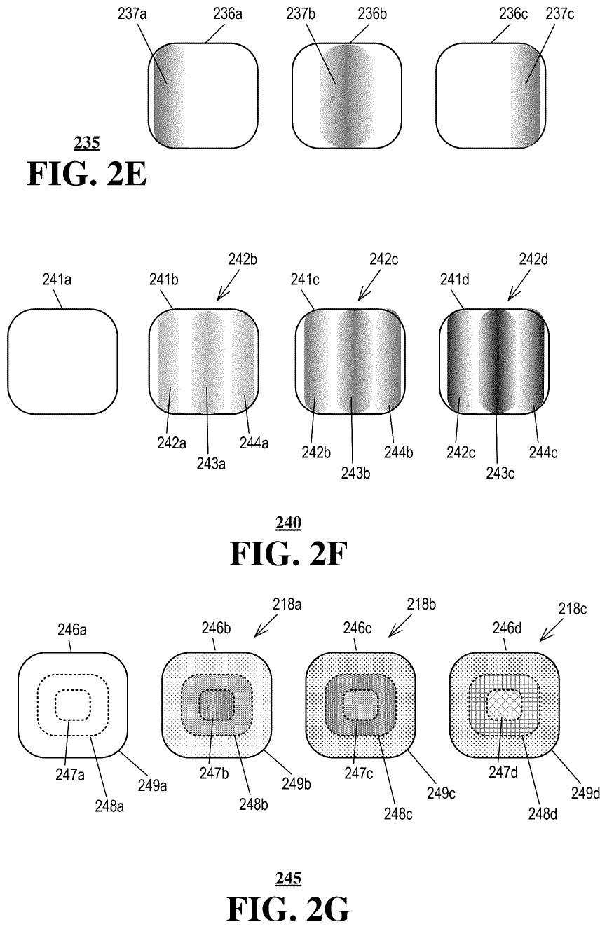

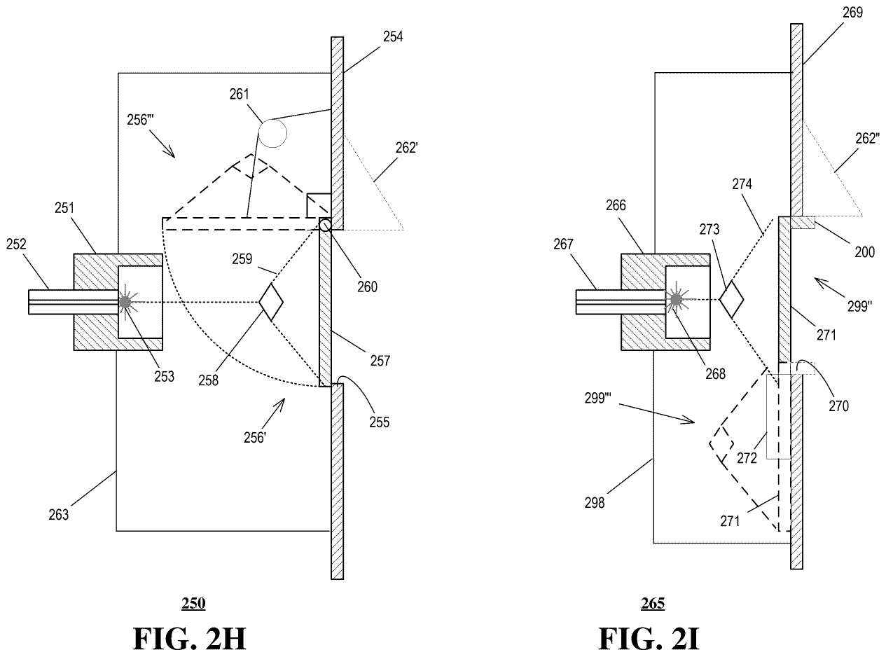

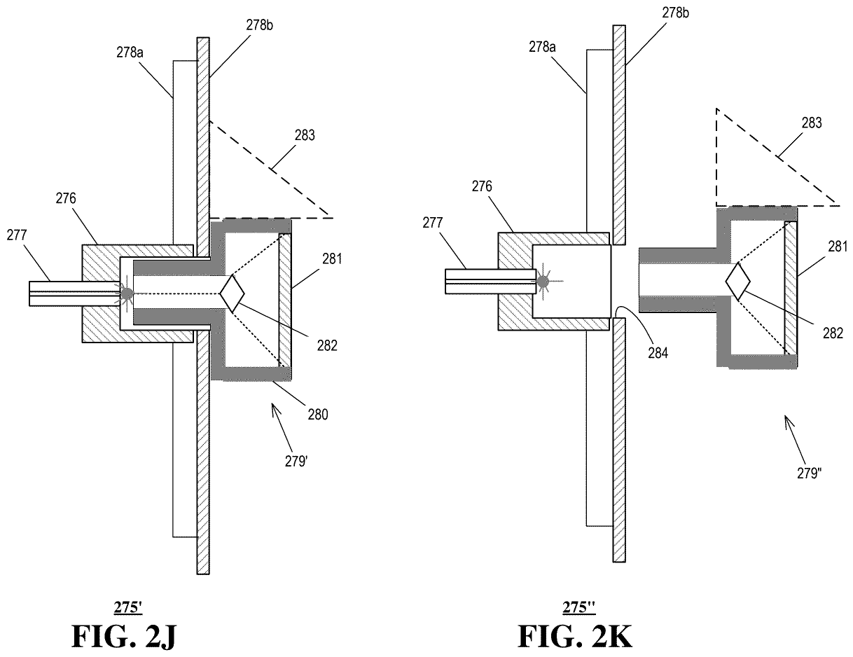

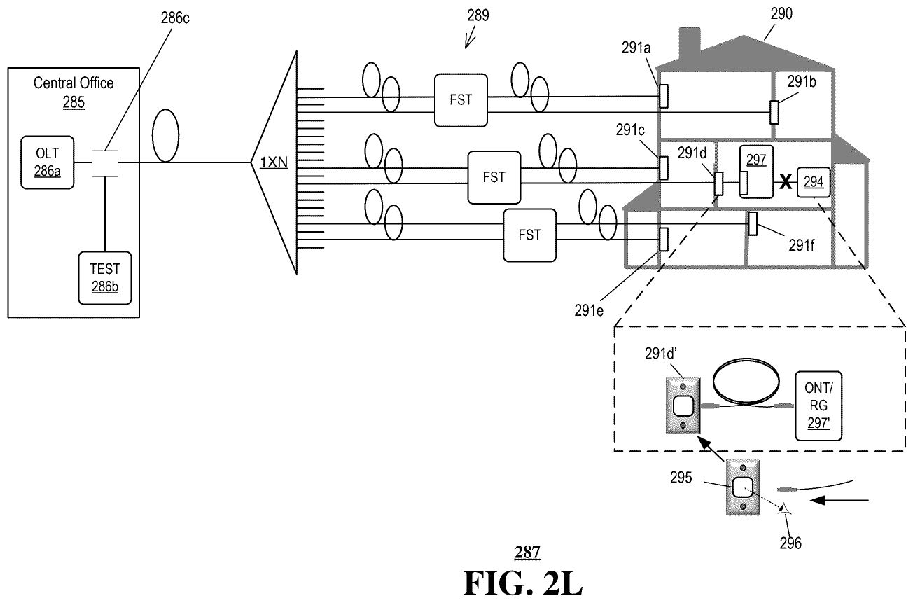

FIG. 2A is a block diagram illustrating an example, non-limiting embodiment of an optical distribution network (ODN) 200 adapted for passively sensing optical signals at a fiber termination and functioning within the communication system 100 of FIG. 1 in accordance with various aspects described herein. The example ODN 200 includes a service provider's central office (CO) 201, an optical line terminal (OLT) 202, a feeder fiber 203, a 1×N splitter 204, distribution fibers 205, fiber serving terminals (FST) 207a, 207b, and 207c, generally 207, optical drop fibers 208a, 208b, and 208c, generally 208, protective fiber jacks 210a′, 210b′, and 210c′, generally 210, a customer premise 209, a visual indicator 212, a legacy protective fiber jack 211, a jumper fiber 214, and an optical power meter 213.

Fiber jacks are installed at service customer locations, such as the example customer premise 209, to terminate optical drop fibers 208. An optical transmission signal from the service provider's CO 201 transmits through the feeder fiber 203, through the splitter 204, through the optical drop fibers 208 and to the fiber jacks 210. Typical deployments require a service technician to connect a handheld optical power meter 213 to the fiber jack 211, e.g., using a jumper fiber 214, to measure and/or otherwise confirm whether optical light is present after installation of the fiber jack 210.

It is understood that such deployments of fiber jacks 210 may be performed long before any customer service is ever activated. In such instances, a customer may order a service, which prompts a service provider to ship equipment to the customer to be self-installed by the customer. Having a fiber jack 210 available and already interconnected to the CO 201 is a prerequisite in such scenarios. However, there are instances in which something may have occurred after an original installation of the fiber jack 210 and an ordering of service that interrupts and/or otherwise compromises operation of the fiber jack 210 as originally deployed. For example, a fiber may have been cut somewhere along the line or disconnected or otherwise compromised such that a downlink or downstream optical signal from the CO 201 is no longer present and/or present at a substantially reduced intensity. In such instances, an ordered service may not be accessible, does not “turn up” when the customer connects the provided equipment to the fiber jack 210. In such instances, it may be necessary to dispatch a technician to the customer premises 209 to check to validate, e.g., using the handheld optical power meter 213, whether an optical transmission signal is present at the fiber jack 210. The technician's measurement results can help to determine whether there is a problem in the optical distribution network, e.g., a broken or kinked fiber, or whether the problem is with the customer premises equipment.

Unfortunately, scheduling a technician visit is both costly and inconvenient as it must be scheduled before a service can be activated. The devices, systems and processes disclosed herein provide an alternative that allow customers to determine a presence and/or status of the optical light present at the fiber jack 210, without having to use the handheld optical power meter 213 and without requiring any special skill.

The CO 201 serves as a starting point of a downlink portion of the ODN 200. The CO 201 includes one or more OLTs 202, which are responsible for transmitting downlink optical signals through the feeder fiber 203. The feeder fiber 203, in turn, connects the CO 201 to a fiber distribution device, in this example, the 1×N splitter 204, which divides the optical signal into “N” multiple paths for distribution.

An OLT 202 is a device used in passive optical networks (PONs) to serve as the endpoint of the optical fiber network at the service provider's CO 201. In at least some embodiments, the OLT 202 manages transmission of data to and from multiple optical network units (ONUs) or optical network terminals (ONTs) 215 as may be located at customer premises 209, converting electrical signals into optical signals for downstream transmission and optical signals into electrical signals for upstream reception. In at least some embodiments, the OLT 202 can be configured to handle network management functions, such as bandwidth allocation and signal distribution.

The example 1×N splitter 204 is operatively coupled to multiple distribution fibers 205, which carry the divided optical signals to various fiber serving terminals (FST) 207a, 207b, and 207c, generally 207. These FSTs 207 serve as intermediate points for further signal distribution, e.g., to individual customer premises 209.

A first FST 207a is connected to an optical drop fiber 208a, which delivers the optical signal to one or more protective fiber jacks 210a′ located at a customer premise 209. Similarly, the second FST 207b and third FST 207c are connected to second optical drop fiber 208b and third optical drop fiber 208c, respectively, which deliver signals to second projective fiber jack 210b′ and third protective fiber jack 210c′ at other customer premises, which may include multiple apartments within the same apartment building, or different households.

Optical fibers offer extremely broadband guided communication channels. By way of example, at least some operational bands used in optical fiber communications include, without limitation: O-Band, accommodating operational wavelengths between about 1260-1360 nm and characterized by low chromatic dispersion, making it suitable for short-distance applications such as local area networks (LANs) and data centers; E-Band, which extends beyond O-Band, accommodating operational wavelengths between about 1360-1460 nm; S-Band, accommodating operational wavelengths between about 1460-1530 nm and commonly used for short-distance communication and is characterized by moderate attenuation; C-Band, accommodating operational wavelengths between about 1530-1565 nm and characterized by low attenuation and compatibility with erbium-doped fiber amplifiers (EDFAs), making it preferable for long-distance transmission and high-capacity networks; L-Band, accommodating operational wavelengths between about 1565-1625 nm characterized by a slightly higher attenuation than the C-band but still suitable for long-distance communication; and U-Band, accommodating operational wavelengths between about 1625-1675 nm and primarily used for network monitoring and testing, e.g., fiber testing as may employ optical time domain reflectometry (OTDR).

Any of the example feeder fibers 203, the distribution fibers 205, the optical drop fibers 208 or the jumper fibers 214 may include multimode fibers having a relatively larger core diameter and capable of carrying multiple light modes simultaneously. Alternatively, or in addition, any one or more of the example fibers may include single mode fibers having a relatively small core diameter and designed for carrying light in a single propagation mode,

The bandwidth of an optical fiber can be characterized in reference to the electromagnetic spectrum. For example, any of the example optical fibers may be configured to accommodate electromagnetic radiation, e.g., in the form of guided signals, in one or more of an infrared (IR) band, a visible band and an ultraviolet (UV) band. The IR band includes electromagnetic radiation having wavelengths longer than visible wavelengths, i.e., greater than about 700 nm, which are invisible to the human eye. The UV band includes electromagnetic radiation having wavelengths shorter than visible wavelengths, i.e., less than about 400 nm, which are also invisible to the human eye. Visible band wavelength refers to the range of electromagnetic wavelengths that can be perceived by the human eye as light. This range typically spans from approximately 400 nanometers (nm) to 700 nanometers (nm). Within this spectrum, different wavelengths correspond to different colors, forming the visible light spectrum, e.g., violet (400-450 nm), blue (450-4495 nm), green (495-570 nm), yellow (570-590 nm), orange (590-620 nm), red (620-700 nm). It is understood that references to fiberoptic transmission signals, optical signals and/or light can include IR, visible, UV and possibly other portions of the electromagnetic spectrum, e.g., microwaves, millimeter waves and so on.

An optical transmitter is a device used in fiber optic communication systems to convert electrical signals into optical signals for transmission through optical fibers. It serves as the starting point of the communication process, enabling high-speed and long-distance data transfer. Optical transmitters are essential components in telecommunications, data centers, and networking applications. In at least some embodiments, a transmitter portion of an OLT 202, an ONU and/or an ONT 215 may include an optical or light source, such as a laser, e.g., a semiconductor laser, a laser diode and/or a light emitting diode (LED). The transmitter may include one or more of a modulator, a driver circuit and/or an optical interface. The modulator can be configured to modulate the light source to encode an optical signal. Modulation techniques include, without limitation, amplitude modulation, frequency modulation, phase modulation, and any combination thereof. The driver circuit may provide electrical signals to the light source based on input data, e.g., to ensure that the light source operates within its optimal range for efficient signal generation. The optical interface couples the optical signal into the optical fiber for transmission and may include, by way of example, any combination of lenses, prisms and/or connectors to alight the light source with a core region of the optical fiber.

Optical distribution networks, such as the example ODN 200 can employ a passive optical network (PON), which may be fed by one or more of the example OLT 202, ONU and/or ONT 215. In general, a PON is a fiber-optic communication system that uses passive components, such as optical splitters and/or combiners, to distribute signals from a CO to multiple end-users without requiring active electronic devices or power in the distribution network. PONs are widely used in telecommunications for delivering high-speed internet, voice, and video services to residential and business customers. PONs rely on passive optical splitters 204 to divide the optical signal from a single fiber, e.g., the feeder fiber 203, into multiple paths, e.g., the distribution fibers 206a, 206b, 206c, generally 206, thereby enabling cost-effective signal distribution. Generally, a PON does not include active components, such as amplifiers or repeaters) are required in the network between the central office and the end-users.

In at least some embodiments, an ODN, such as the example ODN 200, includes PON configured to facilitate delivery of broadband services to multiple users at multiple locations, including multiple users within an apartment complex and/or office building, as well as users at physically separated homes, offices, apartment buildings, and so on. The PON can include a single optical fiber, e.g., the feeder fiber 203, from the CO 201 that serves multiple end-users through passive splitters, e.g., the example 1×N splitter 204, to reduce infrastructure costs. The OLT 202 at the CO 201 can be configured to manage the network 200, while the ONUs and/or ONTs 215 at the customer premises 209 handle signal reception and conversion. In at least some embodiments, at least some of the ONUs and/or ONTs 215 include optical transmitters that support upstream and/or uplink communications directed from the ONUs and/or ONTs 215 to the OLT 202 at the CO 201. In this direction, the example 1×N splitter 204 can operate as an optical signal combiner, e.g., an optical power combiner configured to combine multiple optical signals originating from ONUs and/or ONTs 215 at multiple premises 209 into a combined uplink signal directed towards the OLT 202.

During a buildout phase, a broadband service provider may deploy physical infrastructure, e.g., cable plant, that provides connectivity between the CO 201 and one or more demarcation points at customer premises, e.g., the example customer premises 209. Consequently, optical fibers terminating at demarcation points, such as the example fiber jacks 210a′, 210a″, 210b′, 210b″, 210c′, 210c″, generally 210, will be active, at least a sense that there will be an optical transmission signal, e.g., originating at the OLT 202. When a new consumer broadband service is activated at a particular premise, the broadband service provider can provide end-user equipment, such as the example ONUs and/or ONTs 215 to the customer. Provisioning the new service can include interconnecting the end-user equipment to a fiber jack 210, among other steps.

Laser light is known to pose several hazards due to its high intensity, coherence, and ability to focus on small areas. For example, laser light can cause severe damage to the retina, cornea, or lens, potentially leading to permanent vision loss, even low-power levels if focused directly into the eye. It is understood that an open end of an optical fiber fed from an optical source can pose such hazards. This can be of particular concern for optical signals in invisible wavelengths, such as IR and/or UV, as a person may not be aware that the fiber is active. In such applications, the fiber demarcation point may include a protective device to reduce the possibility of exposure to laser light. In at least some embodiments, the protective device can include a movable and/or otherwise configurable shield adapted to prevent exposure to laser light when the demarcation point is open, unused and/or otherwise not interconnected to another device and/or optical fiber cable. By way of example, the protective device can block, occlude and/or otherwise cover an exposed end of an optical fiber at the demarcation point.

In at least some embodiments, the fiber termination point includes a fiberoptic connector. Example fiberoptic connectors include, without limitation: SC (subscriber connector) push-pull connector with a square shape, providing simple to use, high precision interconnects, as widely used in data centers and networks; and fiber-to-the-home (FTTH), cable TV, and LANs. Other variants include LC (Lucent connector) connectors having a small form factor with a latch mechanism and well adapted for use in high-speed networks; ST (straight tip) connectors having a bayonet-style connector with a round shape that is easy to install, and commonly used in industrial applications; FC (ferrule connector) having a screw-type connector with a cylindrical shape; and MTP/MPO (multi-fiber push-on) connectors designed for multi-fiber cables, e.g., supporting up to 12 or 24 fibers. Still other example types of optical fiber connectors include, without limitation, E2000 connectors including a spring-loaded shutter to protect the ferrule and LC/APC and SC/APC (angled physical contact) connectors with an angled ferrule end-face to reduce back reflection. It is worth noting here that the ferrule can include a cylindrical part configured to hold and/or otherwise align an optical fiber, typically made of ceramic, metal, or plastic.

Alternatively, or in addition, the fiber demarcation point includes an exposed fiber end suitable for interconnection via an optical fiber splice to another fiber and/or device, e.g., a device having an optical fiber pigtail. It is envisioned that a protective device, at any of the aforementioned example optical fiber terminations, can be positioned and/or otherwise configured to block any light that may be emitted from the fiber demarcation point. This can include a moveable screen, e.g., that may slide and/or pivot between an open position to accommodate interconnections and a closed position to provide hazard protection. In at least some embodiments, the protective device may include a shutter, such as used in the E2000 connectors, that can be configured to open to accommodate interconnection and close to provide hazard protection.

In connector terminology, a mating pair may include a jack and a plug. The jack can represent a fixed or stationary connector, which may be mounted on a device, a wall or a panel, serving as a receptable into which a plug can be inserted to establish a connection. In at least some embodiments, a jack provides structural support for the connection, which may also include a protective features, such as shutters or covers, e.g., dust caps, to prevent contamination or damage to the optical fiber when not in use. Alternatively, or in addition a jack may include other features designed to align the optical fiber core precisely for efficient signal transmission. The plug generally represents a movable or detachable connector that can be inserted into a jack to complete the connection. A plug contains an optical fiber and mates with a jack to ensure proper alignment and signal transmission. A plug may include other features, such as a ferrule to hold and align the fiber core, and/or a locking mechanism, such as a latch or bayonet, to secure the connection. In at least some embodiments, a plug may include a protective cover for transport and storage. Collectively, the jack and plug can be configured to facilitate easy insertion and removal, in at least some embodiments, without the aid of tools.

The example protective fiber jack 210a′ also includes a visual indicator 212 coupled to and/or otherwise integrated with the protective fiber jack 210a′, which can be configured to provide a visual indication as to a presence of an optical signal as may result from an unterminated PON demarcation point. In at least some embodiments, the visual indicator 212 is configured to provide a representation of one or more physical properties of an optical signal, such as intensity and/or wavelength. Such visual indicators facilitate troubleshooting without external diagnostic equipment. For example, an untrained consumer may be able to interpret a visual indication of the visual indicator 212 as may be beneficial during self-guided troubleshooting and/or troubleshooting with the assistance of a helpdesk. It is envisioned that the visual indicator 212 can be beneficial to an end consumer, e.g., verifying the presence of an optical signal which may be an indicator that a service can be provisioned without requiring the services of a local technician. Likewise, the visual indicator 212 can be beneficial to a network service provider, e.g., verifying the presence of an optical signal which may be an indicator that the PON may be functioning properly, thereby facilitating fault isolation to other parts of the network, without necessarily having to provide local technician assistance.

The legacy fiber jack 211 is shown in a detailed view alongside a jumper fiber 214 and an optical power meter 213. The legacy fiber jack 211 is used in traditional setups for signal testing, where the jumper fiber 214 connects the legacy protective fiber jack 211 to the optical power meter 213, which measures the optical signal's power level for diagnostic purposes. Namely, without the disclosed visual indicator 212, a technician would have to connect the optical power meter 213 or similar device at the PON demarcation point, e.g., the legacy fiber jack 211, using the fiber jumper in order to determine a physical property of a downlink PON signal, e.g., from the OLT 202, such as its presence, its intensity and/or wavelength.

FIG. 2B is a block diagram illustrating an example, non-limiting embodiment of a jack housing 220 functioning within the optical distribution network 200 of FIG. 2A and the communication system 100 of FIG. 1 in accordance with various aspects described herein. In more detail, FIG. 2B shows the jack housing 220, which includes an integrated passive optical sensing assembly 221. The jack housing 220 includes a cover plate 222 defining an aperture 223 therein, and a passive optical sensing assembly 221, which includes a shutter 224 that collectively facilitate the passive sensing of optical signals. The jack housing 220 provides structural support and protection for the components of the passive optical sensing assembly 221, such as an optical connector, e.g., a fiberoptic jack, which may include a ferrule for aligning an end of an optical fiber.

The jack housing 220 is designed to accommodate the passive optical sensing assembly 221 and ensure secure installation within a wall, a panel and/or a device. In at least some embodiments, the jack housing 220 includes the cover plate 222, which can be configured to function as an external enclosure, shielding the internal components from environmental factors, e.g., a jack which may include an exposed optical fiber end and/or a ferrule, with the shielding preventing exposure to laser light, e.g., via optical signals as may emanate from unterminated fibers, while also providing access to the optical sensing features.

The cover plate 222 defines the aperture 223 as an opening through which a plug may be inserted into the jack to form an optical interconnect, while also serving as a physical structure or mount for supporting and/or otherwise securing the passive optical sensing assembly 221. The cover plate 222 prevents dust, debris, and other contaminants from entering the assembly while preserving functionality of the jack termination as does the shutter 224, which may include and/or otherwise support an optical sensing mechanism.

In more detail, the aperture 223 is a defined opening within the cover plate 222 that permits the fiberoptic transmission signal to pass through and engage with the internal sensing components. The aperture 223 can be strategically sized and/or otherwise positioned to enhance positioning and/or exposure of the shutter 224 to facilitate placement of a photosensitive material in relation to a laser light source, such as an exposed fiber end and/or connector ferrule.

According to the illustrative embodiment, the shutter 224 is operable to selectively occlude or expose a laser source, such as the exposed fiber end and/or connector ferrule as may be aligned with the aperture 223. This shutter 224 facilitates control over the propagation of the fiberoptic transmission signal, enabling the passive optical sensing assembly 221 to perform efficiently in a closed configuration, while also protecting from any hazard of laser exposure outside of the cover plate 222.

FIG. 2C is a block diagram illustrating another example, non-limiting embodiment of a passive, optical sensing jack housing 220′ functioning within the optical distribution network 200 of FIG. 2A and the communication system 100 of FIG. 1 in accordance with various aspects described herein. In more detail, FIG. 2C shows a jack housing 220′, such as the example jack housing 220 (FIG. 2B), integrated within an optical distribution network (ODN) 210 (FIG. 2A). The example jack housing 220′ includes a cover plate 222′ defining an aperture 223, and the passive optical sensing assembly 221′. In at least some embodiments, the passive optical sensing assembly 221′ includes a shutter 224′ designed to facilitate passive sensing of optical signals, providing visual feedback regarding the physical properties of fiberoptic transmission signals, while also providing environmental protection and/or protection from exposure to laser radiation outside of the example jack housing, e.g., beyond the cover plate 222′.

In at least some embodiments, at least a portion of the cover plate 222′ and/or a shutter 224′ portion of the passive optical sensing assembly 221′ is configured to respond to a physical property of an optical signal, e.g., a strength and/or wavelength of laser light which may be emitted from an optical fiber end as may be present within the jack and/or ferrule contained within the example jack housing 220′. According to the illustrative example, the shutter displays a visual pattern 216, e.g., a vertical stripe visible from an external side of the cover plate 222′ responsive to illumination by laser light, e.g., from a fiberoptic transmission signal from the CO 201 (FIG. 2A) as may be conveyed to the jack via the example PON network. It is understood that the example visual pattern 216 may change responsive to a change to a physical property of the optical signal. For example, if the optical signal were not present as may result from a disturbance in the PON, the example visual pattern 216 may not be present at the shutter 224.

FIG. 2D is a block diagram illustrating an example, non-limiting embodiment of a passive, optical sensing assembly 225 functioning within the optical distribution network 200 of FIG. 2A and the communication system 100 of FIG. 1 in accordance with various aspects described herein. The passive optical sensing assembly 225 is configured for passively sensing optical signals, such as fiberoptic transmission signals as may originate from a remote transmitter that incorporates a laser device as a source. According to the illustrative example, the passive optical sensing assembly 225 includes a screen, e.g., a shutter 226, and a local optical source 227, such as an exposed fiber end as may be presented within a fiberoptic jack and/or ferrule provided therein. In at least some embodiments, the passive optical sensing assembly 225 also includes a beam spreader 228. According to the illustrative example, the shutter 226 includes at least one supporting layer 229, and at least one reactive layer 230. These components, e.g., the supporting layer(s) 229 and/or the reactive layer(s) 230 can be configured to work in conjunction to provide a visual indication of a physical properties of the local optical source 227, which may correspond to a fiberoptic transmission signal received through an optical fiber (not shown). For example, the reactive layer 230 may include a device, material and/or compound configured to respond to illumination by laser light by providing a visual indication.

In at least some embodiments, a visual response to laser illumination may result from a physical process of the reactive layer(s) 230, which may contain a photosensitive material. For example, a photosensitive material and/or substance may be configured to detect one or more of UV, visible, near-IR (NIR) or mid-IR (MIR) laser beam presence, Absorption of the laser light in such materials can be used to charge the materials to change and/or alter a visual appearance. In at least some embodiments, such changes in visual appearance caused by absorption of laser light can indicate whether electromagnetic radiation of a particular wavelength is present.

At least one such physical process is photoluminescence. For example, a slow-fading phosphor material can be used, which enables the location of light beams and focal points. In general, a phosphor is a substance that exhibits a phenomenon of luminescence. Namely, a phosphor emits light when exposed to some type of electromagnetic radiation. In operation, the reactive layer(s) 230 may absorb photons at a first wavelength corresponding to the fiberoptic transmission signal, e.g., in an invisible band, such as the IR band and/or the UV band. In response to the absorption, the reactive layer(s) 230 generate photons at another band, preferably residing within the visible spectrum such that an observe can identify the presence of the fiberoptic transmission signal, which may be operating an invisible spectrum, by a visible indication provided by photons emitted by the reactive layer(s) 230 in the visible spectrum. Thus, an observer can identify the presence of the fiberoptic transmission signal, even one operating in an invisible portion of the spectrum, without requiring any test equipment.

Photoluminescence is the emission of light from a material after it absorbs photons (light energy). This phenomenon occurs when a material absorbs light or electromagnetic radiation, causing its electrons to become excited to a higher energy state. When these excited electrons return to their lower energy state, they release the absorbed energy in the form of light. The emitted light has a different wavelength, generally a longer wavelength (lower energy) than the absorbed light due to energy losses during the process. Photoluminescence begins when a material absorbs photons, exciting electrons from their ground state to a higher energy state. The emission occurs when the electrons return to their ground state, releasing energy as light. The emitted light often has a longer wavelength than the absorbed light due to energy losses, such as vibrational relaxation, during the excitation-emission process. At least one type of photoluminescence process is fluorescence, whereby the emission occurs almost immediately (within nanoseconds) after excitation. At least one other type of photoluminescence process includes phosphorescence, which is a slower form of photoluminescence whereby the emission persists for a longer time (milliseconds to minutes) due to the involvement of metastable states.

According to the electromagnetic spectrum, ultraviolet short waves occur at wavelengths of around 250 nm and are referred to as UVC, representing a relatively high energy emissions. Ultraviolet medium waves occur at wavelengths of around 300 nm and are referred to as UVB. Ultraviolet long waves occur at wavelengths of around 370 nm and are referred to as UVA. In the visible spectrum, blue light has a wavelengths of about 400 nm and red light has wavelengths of about 700 nm, while infrared occur at wavelengths of between about 700-8,000 nm representing a relatively lowest energy level. An unusual phenomenon called “up-conversion” is an anti-Stokes process whereby a material absorbs lower energy photons and emits high energy photons which can illuminate phosphors.

Materials that exhibit phosphorescence properties include, alone or in combination, phosphors, quantum dots, organic dyes and rare earth elements. Phosphors are materials that exhibit photoluminescence, commonly used in lighting and display technologies. Examples include, without limitation, yttrium aluminum garnet (YAG) doped with cerium for white LEDs. Quantum dots are nanoscale semiconductors that exhibit size-dependent photoluminescence, used in displays and imaging. Examples include cadmium selenide (CdSe) quantum dots. Organic dyes are fluorescent dyes commonly used in biological imaging and sensing. Examples include, without limitation, rhodamine and fluorescein. Rare earth elements are materials doped with rare earth ions, such as europium or terbium, exhibit strong photoluminescence. Examples include, without limitation, europium-doped phosphors for red light emission. In at least some embodiments, the reactive layer 230 may be configured to respond to one or more physical properties of the laser light, such as its intensity and/or wavelength.

In at least some embodiments, a photosensitive material may be applied to a substrate, such as the example screens or shutters that can be configured to intersect an optical beam as may be emitted form an open fiber end and/or an unterminated fiber jack 210. In some embodiments, the photosensitive material may be formed as a rigid, semirigid and/or pliable of floppy structure that may be attached to a substrate, e.g., the example screens and/or shutters with an adhesive. Alternatively, or in addition, the photosensitive material may be applied as a paint and/or via a deposition process, such as a chemical vapor deposition process and/or a sputtering process. In at least some embodiments, the photosensitive material may be integrated within and/or formed as a sufficiently rigid structure that provides at least a portion of the example screens and/or shutters. Alternatively, or in addition, the screen and/or shutter could include a type of glass or similar supportive structure with a rigid, semi-rigid or flexible physical property. The screen and/or shutter, e.g., the glass, may be smooth and/or textured and at least partially coated with a photosensitive material to provide a visible reaction. In some embodiments, the photosensitive material coating may coat substantially all of the screen and/or shutter. Alternatively, or in addition, the photosensitive material coating may be applied to a selective region or sub-region of the supporting screen and/or shutter. In at least some embodiments, the selective region and/or sub-region may define a symbol, such that when activated by laser light, the coating may provide a visible indication to a user in a form of the symbol, e.g., a shape, a design, a letter, a group of letters, and/or a word.

In at least some embodiments, the screen or shutter 226 can positioned as a movable element within the passive optical sensing assembly 225. For example, the shutter 226 can be repositionable and/or configurable to selectively expose, block, shield, and/or otherwise occlude internal components of the assembly, thereby controlling interaction of the fiberoptic transmission signal with the reactive layer 230. In so doing, the shutter 226 can prevent a substantial portion of the laser light from passing therethrough. This feature offers protection from exposure to the laser light when the shutter 226.

The example configuration enhances the functionality of the passive optical sensing assembly 225 by enabling precise control over the sensing process. The local optical source 227, e.g., the exposed fiber end, represents the terminal point of the optical fiber where the fiberoptic transmission signal exits. The local optical source 227 directs the signal toward the beam spreader 228, ensuring that the optical signal is properly aligned for subsequent dispersion. This alignment plays a significant role in the accurate operation of the passive optical sensing assembly 225.

The beam spreader 228 is positioned between the local optical source 227, e.g., the exposed fiber end, and the reactive layer 230. The beam spreader 228 is configured to disperse the fiberoptic transmission signal over a predetermined area of the reactive layer 230. This dispersion ensures that the signal interacts uniformly with the reactive layer 230, enabling the detection of the physical properties of the reactive layer 230, such as intensity or wavelength. In at least some embodiments, the beam spreader 228 can include one or more of a lens, a diffuser, a prism, and/or a hologram alone or in any combination. It is understood that laser light emitted from a local optical source 227, without the bream spreader 228, will illuminate a first region A₁ on the shutter 226, e.g., on the reactive layer 230 having a first size, e.g., a first spot having a first diameter d₁. In at least some embodiments, the resulting first spot size may be sufficiently visible such that a beam spreader is unnecessary. In at least some embodiments, it may be necessary to increase a size of a visual indication on the shutter 226. Accordingly, the beam spreader 228 can be configured to redirect, resize and/or otherwise reshape light emitted from the local optical source 227, e.g., to illuminate a second region on the shutter 226 having a second region A₂ greater than the first, i.e., A₂>A₁. For a spot size, the resulting spread spot might have a second diameter d₂ greater than the first, i.e., d₂>d₁.

The supporting layer 229 can be located adjacent to the reactive layer 230, e.g., providing structural stability to the passive optical sensing assembly 225. This configuration helps keep the reactive layer 230 securely positioned within the passive optical sensing assembly 225, to preserve functionality of the sensing mechanism, e.g., the reactive layer 230, during operation. It is envisioned that the supporting layer 229 may include any combination of plastics, a glass and/or ceramic. In at least some embodiments, the supporting layer 229 may be sufficiently translucent to facilitate external observation of a visual indication provided by and/or occurring within the reactive layer 230. For example, the supporting layer 229 may be constructed of a substantially clear material, such as a clear plastic or glass.

Although the illustrative embodiment of the passive optical sensing assembly 225 includes one reactive layer 230 positioned on an optical source side of the supporting layer 229, e.g., on the same side as the local optical source 227, it is understood that, alternatively, or in addition, the reactive layer 230 may be positioned at least partially on an external side of the supporting layer 229 and/or incorporated within the supporting layer, e.g., as an internal layer and/or as aggregate particles or fragments as may be incorporated within the supporting layer 229. In at least some embodiments, one or more other layers may be included (not show), such as filter layers, structural layers, symbolic layers, e.g., incorporating one or more screens adapted to shield at least part of incident photons from the local optical source 227 and/or photons emitted from the reactive layer(s) 230. It is envisioned that in at least some embodiments, a screen layer may provide a symbol, such as a letter and/or an image as may further facilitate readability and/or interpretability of a resulting visual indication. Filtering layers, if included, may operate to filter one or more of incident photons from the local optical source 227 and/or photons emitted from the reactive layer(s) 230.

The reactive layer 230 is a photosensitive material that undergoes a visible change in response to the absorption of light from the fiberoptic transmission signal. This visible change corresponds to a physical property of the signal, such as the intensity or wavelength of the signal, providing a clear visual indication without the need for external diagnostic equipment.

It is understood that different areas or regions of the reactive layer 230 may include different materials as may be adapted to respond differently to one or more of incident photons from the local optical source 227 and/or photons emitted from the reactive layer(s) 230. For example, a first region of the reactive layer 230 may emit first visible photons responsive to absorbing first group of photons in a first wavelength region, e.g., IR photons, while a second region of the reactive layer 230 may emit second visible photons responsive to absorbing a second group of photons in a second wavelength region, e.g., UV photons. In at least some embodiments, the second photons may be photons of different wavelengths, e.g., different colors within the visible spectrum. Alternatively, or in addition, the first and second regions are distinguishable, such that in either instance, an observer may readily distinguish a presence and/or absence of either or both of the first and second groups of photons.

FIG. 2E is a block diagram illustrating an example, non-limiting embodiment of a passive optical sensor 235 functioning within the jack housing assemblies 220, 220′ of FIGS. 2B, 2C and the optical sensing assembly 225 of FIG. 2D in accordance with various aspects described herein. The passive optical sensor 235 includes a first shutter 236a configured to provide a first visual indication, i.e., a first pattern 237a responsive to a first physical property of a detected fiberoptic transmission signal. In at least some embodiments, the passive optical sensor 235 includes a second shutter 236b configured to provide a second visual indication, i.e., a second pattern 237b responsive to a second physical property of the detected fiberoptic transmission signal. Alternatively, or in addition, the passive optical sensor 235 includes a third shutter 236c configured to provide a third visual indication, i.e., a third pattern 237c responsive to a third physical property of the detected fiberoptic transmission signal. These components interact to provide visual feedback regarding the physical properties of fiberoptic transmission signals.

The first pattern 237a may result from a first photosensitive element within the passive optical sensor 235 that undergoes a first visible change in response to the absorption of the first physical property of the fiberoptic transmission signal, e.g., photons within a first intensity range and/or within a first wavelength region. Accordingly, a visible change resulting in the first pattern 237a may provide a visual indication that the passive optical sensor 235 has been exposed to a fiberoptic transmission signal expressing the first physical property. Likewise, the second pattern 237b may result from a second photosensitive element within the passive optical sensor 235 that undergoes a second visible change in response to the absorption of the second physical property of the fiberoptic transmission signal, e.g., photons within a second intensity range and/or within a second wavelength region. Accordingly, a visible change resulting in the second pattern 237b may provide a visual indication that the passive optical sensor 235 has been exposed to a fiberoptic transmission signal expressing the second physical property. Similarly, the third pattern 237c may result from a third photosensitive element within the passive optical sensor 235 that undergoes a third visible change in response to the absorption of the third physical property of the fiberoptic transmission signal, e.g., photons within a third intensity range and/or within a third wavelength region. Accordingly, a visible change resulting in the third pattern 237c may provide a visual indication that the passive optical sensor 235 has been exposed to a fiberoptic transmission signal expressing the third physical property.

In at least some embodiments, a single shutter 236 may express one or more of the first pattern 237a, the second pattern 237b and/or the third patter 237c. The shutter 236a, 236b, 236c, generally 236, can be provided as a movable component that selectively occludes or exposes the fiberoptic transmission signal.

FIG. 2F is a block diagram illustrating another example, non-limiting embodiment of a passive optical sensor 240 functioning within the jack housing assemblies 220, 220′ of FIGS. 2B, 2C and the optical sensing assembly 225 of FIG. 2D in accordance with various aspects described herein. The passive optical sensor 240 includes a first screen 241a adapted to present a first pattern 242a responsive to absence of the fiberoptic transmission signal, e.g., a blank pattern. In at least some embodiments, the passive optical sensor 240 includes a second screen 241b adapted to present a second pattern 242b responsive to one or more second physical properties of the fiberoptic transmission signal, a third screen 241c adapted to present a third pattern 242c responsive to one or more third physical properties of the fiberoptic transmission signal, and a fourth screen 241d adapted to present a fourth pattern 242d responsive to one or more fourth physical properties of the fiberoptic transmission signal. In at least some embodiments, the first, second, third and fourth screens 241a, 241b, 241c, 241d, may include a single screen 241 configured to respond according to the illustrative example.

By way of example, the first pattern 242b can include a first group of patterns 242a, 243a, 244a, e.g., distinguishable vertical stripes, at a first group of intensity levels, e.g., at a first relatively low intensity. Likewise, the second pattern 242b can include a second group of patterns 242b, 243b, 244b, e.g., distinguishable vertical stripes, at a second group of intensity levels, e.g., at a second relatively intermediate intensity. Similarly, the third pattern 242c can include a third group of patterns 242c, 243c, 244c, e.g., distinguishable vertical stripes, at a third group of intensity levels, e.g., at a third relatively high intensity. These groups of patterns 242, 243, 244 interact to provide visual feedback regarding the physical properties of fiberoptic transmission signals.

The screen 241 can be positioned as a movable element within the passive optical sensor 240. In at least some embodiments, the screen 241can function as a shutter to selectively occlude or expose the internal components of the sensor, thereby managing the interaction of the fiberoptic transmission signal with the screen 241 and subsequent sensing elements. This arrangement improves the operation of the passive optical sensor 240 by allowing refined control over the sensing process.

In at least some embodiments, the screen 241 can serve as a primary interface for the fiberoptic transmission signal within the passive optical sensor 240. The screen 241 can be designed to interact with the fiberoptic transmission signal according to photosensitive patterns of the screen(s) 241, intensities, and/or wavelengths of the fiberoptic transmission signal, thereby facilitating detection and visualization of the signal's physical properties. In at least some embodiments, the screen 241 is configured to ensure that a substantial portion of the fiberoptic transmission signal is appropriately distributed across a sensing elements for accurate feedback.

FIG. 2G is a block diagram illustrating yet another example, non-limiting embodiment of a passive optical sensor 245 functioning within the jack housing assemblies 220, 220′ of FIGS. 2B, 2C and the optical sensing assembly 225 of FIG. 2D in accordance with various aspects described herein. FIG. 2G illustrates an embodiment of a passive optical sensor 245 designed to facilitate the passive sensing of optical signals. The passive optical sensor 245 includes a screen 246 including a group of symbolic regions 247, 248, 249 configured to respond to respective physical properties of incident laser light as might result from illumination by a fiberoptic transmission signal. According to stimulation by a first laser light as might result from illumination by a first fiberoptic transmission signal results in a first visual pattern 218a, providing first visual feedback regarding a first group of physical properties of the first fiberoptic transmission signal. Likewise, according to stimulation by a second laser light as might result from illumination by a second fiberoptic transmission signal results in a second visual pattern 218b, providing second visual feedback regarding a second group of physical properties of the second fiberoptic transmission signal. Similarly, according to stimulation by a third laser light as might result from illumination by a third fiberoptic transmission signal results in a third visual pattern 218c, providing third visual feedback regarding a third group of physical properties of the third fiberoptic transmission signal.

The screen 246 serves as the initial interface for the fiberoptic transmission signal within the passive optical sensor 245. The components, e.g., the group of symbolic regions 247, 248, 249, interact to enable precise detection and visualization of signal characteristics such as intensity and wavelength. These symbolic patterns interact with the symbolic regions 247a, 247b, 247c, 247d, 248a, 248b, 248c, and 249a, 249b, 249c, 249d to provide comprehensive visual feedback, ensuring robust and accurate detection of the fiberoptic transmission signal's physical properties.

FIG. 2H is a block diagram illustrating an example, non-limiting embodiment of a passive, optical sensing, fiber termination assembly 250 functioning within the optical distribution network 200 of FIG. 2A and the communication system 100 of FIG. 1 in accordance with various aspects described herein. The passive, optical sensing, fiber termination assembly 250 includes a jack housing 263, a jack 251, a fiber 252, an exposed fiber end 253, a faceplate 254, a plug accepting aperture 255, an shutter assembly 260′ (shown in phantom) and a shutter assembly in a closed configuration 256′, generally a shutter assembly 256, a pivot 260, a spring 261, an optional shroud 262 (shown in phantom), a support 259, a beam spreader 258, and a shutter 257. These components interact to offer protection from inadvertent exposure to laser radiation, while facilitating passive sensing of optical signals and providing visual feedback regarding the physical properties of the laser radiation as may result from fiberoptic transmission signals, e.g., downstream signals originating at a CO 102 (FIG. 2A).

In at least some embodiments, the jack housing 263 of the passive, optical sensing, fiber termination assembly 250 serves as an external enclosure for a fiber termination assembly, e.g., a fiber connector component, providing structural support and/or protection for the internal components. The example design accommodates a fiberoptic jack 251 and other elements, promoting durability and facilitating integration into customer premises.

The fiberoptic jack 251 is positioned within the jack housing 263 and serves as the interface for the fiber 252. The fiber 252 can be routed through the jack 251, terminating at an exposed fiber end 253. The exposed fiber end 253 represents a terminal point of the fiberoptic transmission signal, e.g., directing the signal toward the shutter 257, by way of the beam spreader 258, when provided for subsequent dispersion. It is anticipated that a beam spreader 258 may not be necessary in at least some embodiments.

The faceplate 254 can be mounted on a front of the jack housing 263 and includes the plug accepting aperture 255. The plug accepting aperture 255 may align with the fiberoptic jack 251, allowing external plugs (not shown) to interface with the passive, optical sensing, fiber termination assembly 250 while maintaining integrity of the internal components. The faceplate 254 may also contribute to the overall protection and/or aesthetic integration of the passive, optical sensing, fiber termination assembly 250.

The shutter assembly 256 includes at least two configurations: the shutter assembly in an open configuration 256″ and the shutter assembly in a closed configuration 256′. The shutter assembly in the open configuration 256″ allows the fiberoptic transmission signal to propagate freely, e.g., to exit the passive, optical sensing, fiber termination assembly 250 via the plug accepting aperture 255 or via an interconnected fiber and/or device, e.g., via plug (not shown) interconnected to the fiberoptic jack 251. The shutter assembly in the closed configuration 256′ is configured to occlude any laser light emanating from the fiber 252, e.g., the fiberoptic signal, thereby enabling controlled sensing operations. In at least some embodiments, the shutter assembly 256 includes a screen or shutter 257 configured to be movable between the open and closed configurations.

In at least some embodiments, the shutter 257 engages the faceplate 254 and/or the housing 263 via the pivot 260. For example, the pivot 260 provides a rotational axis for the shutter 257, enabling movement of the shutter 257 between the open and closed positions. In at least some embodiments, a biasing element, e.g., the spring 261, is provided and configured to bias the shutter 257 in a default configuration, e.g., in the closed position. The spring 261 may be operatively coupled to the pivot 260 and assists in maintaining the desired position of the shutter 257, ensuring reliable operation.

In at least some embodiments, the passive, optical sensing, fiber termination assembly 250 and/or the shutter assembly 256 includes a shroud 262. The shroud 262 can be positioned adjacent to the faceplate 254 and the shutter 257 in its closed position, thereby serving as an additional protective layer for the internal components. The shroud can prevent dust, debris, and other contaminants from interfering with the functionality of the assembly. Alternatively, or in addition, the shroud 262 may shield ambient light to facilitate a reading of a visual indication as may be provide by the shutter assembly 256.

In at least some embodiments, one or more of the jack housing 263 or the shutter assembly 256 includes at least one structural support 259. The example structural support 259 is located within the passive, optical sensing, fiber termination assembly 250 and provides structural stability to the beam spreader 258 and/or other internal components. The beam spreader 258 can be positioned between the exposed fiber end 253 and the shutter 257, dispersing the fiberoptic transmission signal over a predetermined area. This dispersion ensures uniform interaction with the sensing elements, enabling accurate detection of the signal's physical properties. The beam spreader 258 can include any of the example devices disclosed herein and/or otherwise generally known, such as any combination of one or more of a lens, a reflector, a diffuser, a prism and/or a hologram.

The described components collectively enable the passive sensing of optical signals, providing visual feedback regarding signal intensity, wavelength, and other physical properties without requiring external diagnostic equipment, utilizing components such as the passive, optical sensing, fiber termination assembly 250, the jack 251, the fiber 252, the exposed fiber end 253, the faceplate 254, the plug accepting aperture 255, the shutter assembly in the open configuration 256″, the shutter assembly in the closed configuration 256′, the pivot 260, the spring 261, the shroud 262, the support 259, the beam spreader 258, and the shutter 257.

FIG. 2I is a block diagram illustrating another example, non-limiting embodiment of a passive, optical sensing, fiber termination assembly 265 functioning within the optical distribution network 200 of FIG. 2A and the communication system 100 of FIG. 1 in accordance with various aspects described herein. The fiber termination assembly 265 includes a jack housing 298, a jack 266, a fiber 267, an exposed fiber end 268, a faceplate 269, a plug accepting aperture 270, an shutter assembly 299″ in an open position (shown in phantom) and a shutter assembly 299′ closed position, generally a shutter assembly 299, a track 272, an optional shroud 262″ (shown in phantom), a support 274, a beam spreader 273, and a screen or shutter 271. These components interact to offer protection from inadvertent exposure to laser radiation, while facilitating passive sensing of optical signals and providing visual feedback regarding the physical properties of the laser radiation as may result from fiberoptic transmission signals, e.g., downstream signals originating at a CO 102 (FIG. 2A).

In at least some embodiments, the jack housing 298 of the fiber termination assembly 265 serves as an external enclosure for a fiber termination assembly, e.g., a fiber connector component, providing structural support and/or protection for the internal components. The example design accommodates a fiberoptic jack 266 and other elements, promoting durability and facilitating integration into customer premises.

The fiberoptic jack 266 is positioned within the jack housing 298 and serves as the interface for the fiber 267. The fiber 267 can be routed through the jack 266, terminating at an exposed fiber end 268. The exposed fiber end 268 represents a terminal point of the fiberoptic transmission signal, e.g., directing the signal toward the shutter 271, by way of the beam spreader 273, when provided for subsequent dispersion. It is anticipated that a beam spreader 273 may not be necessary in at least some embodiments.

The faceplate 269 can be mounted on a front of the jack housing 298 and includes the plug accepting aperture 270. The plug accepting aperture 270 may align with the fiberoptic jack 266, allowing external plugs (not shown) to interface with the fiber termination assembly 265 while maintaining integrity of the internal components. The faceplate 269 may also contribute to the overall protection and/or aesthetic integration of the fiber termination assembly 265.

The shutter assembly 299 includes at least two configurations: the shutter assembly 299″ in the open configuration and the shutter assembly 299′ the closed configuration. The shutter assembly 299″ in the open configuration allows the fiberoptic transmission signal to propagate freely, e.g., to exit the fiber termination assembly 265 via the plug accepting aperture 270 or via an interconnected fiber and/or device, e.g., via plug (not shown) interconnected to the fiberoptic jack 266. The shutter assembly 299′ in the closed configuration is configured to occlude any laser light emanating from the fiber 267, e.g., the fiberoptic signal, thereby enabling controlled sensing operations. In at least some embodiments, the shutter assembly 299 includes a screen or shutter 271 configured to be movable between the open and closed configurations.

In at least some embodiments, the shutter 271 engages the faceplate 269 and/or the housing 298 via the slidable track 272. For example, the slidable track 27 permits and/or otherwise constrains movement of the shutter 271 along a translational axis, enabling movement of the shutter 271 between the open and closed positions. In at least some embodiments, a biasing element, e.g., a spring (not shown), may be provided and configured to bias the shutter 271 in a default configuration, e.g., in the closed position. The spring may be operatively coupled to the housing 298 and/or the faceplate 269 and assists in maintaining the desired position of the shutter 271, ensuring reliable operation.

In at least some embodiments, the jack housing assembly 265 and/or the shutter assembly 299 includes a shroud 262″. The shroud 262″ can be positioned adjacent to the faceplate 269 and the shutter 271 in its closed position, thereby serving as an additional protective layer for the internal components. The shroud 262″ can prevent dust, debris, and other contaminants from interfering with the functionality of the assembly. Alternatively, or in addition, the shroud 262″ may shield ambient light to facilitate a reading of a visual indication as may be provide by the shutter assembly 299.

In at least some embodiments, one or more of the jack housing 263 or the shutter assembly 299 includes at least one structural support 274. The example structural support 274 is located within the fiber termination assembly 265 and provides structural stability to the beam spreader 273 and/or other internal components. The beam spreader 273 can be positioned between the exposed fiber end 268 and the shutter 271, dispersing the fiberoptic transmission signal over a predetermined area. This dispersion ensures uniform interaction with the sensing elements, enabling accurate detection of the signal's physical properties. The beam spreader 273 can include any of the example devices disclosed herein and/or otherwise generally known, such as any combination of one or more of a lens, a reflector, a diffuser, a prism and/or a hologram.

The described components collectively enable the passive sensing of optical signals, providing visual feedback regarding signal intensity, wavelength, and other physical properties without requiring external diagnostic equipment, utilizing components such as jack housing 263, jack 266, fiber 267, exposed fiber end 268, faceplate 269, plug accepting aperture 270, shutter assembly-open 299″, shutter assembly-closed 299′, track 272, shroud 262″, support 274, beam spreader 273, and shutter 271.

FIG. 2J is a block diagram illustrating yet another example, non-limiting embodiment of a passive-sensing fiberoptic termination assembly 275′, shown in an engaged configuration and functioning within the optical distribution network 200 of FIG. 2A and the communication system 100 of FIG. 1 in accordance with various aspects described herein. The passive-sensing fiberoptic termination assembly 275′ includes a jack housing 278a, a jack 276, a fiber 277, a faceplate 278b, a passive-sensing detector plug assembly 279′. The passive-sensing detector plug assembly 279′, in turn, includes a plug housing 280, a screen 281, a beam spreader 282, and an optional shroud 283 (shown in phantom). These components interact to facilitate sensing of optical signals, without requiring active components, e.g., powered electronic components, such as detectors and display indicators, e.g., LEDs. The passive sensing detector plug assembly 279′ provides at least two functions. Firstly, it shields, blocks and/or otherwise occludes an unterminated fiber 277 as may otherwise be exposed by an open jack 276. Secondly, it provides feedback regarding at least one physical property of laser light, e.g., as may result from an ever-present fiberoptic transmission signal of an active PON network.

The jack housing 278a may serves as an external enclosure and/or support for the jack 276 and/or the fiber 277. In at least some embodiments, the jack housing 278a provides an enclosure, e.g., a box having an opening to accommodate passage of an optical fiber and a substantially hollow interior to house the jack 276. The jack housing 278a may have an open end that can be covered by a faceplate 278b to complete an enclosure of the jack 276. Alternatively, or in addition, the jack 276 may be fixedly attached and/or otherwise fastened to the faceplate 278b, in which instance the faceplate 278b and/or some other integral structure of the faceplate 278b may provide the jack housing 278a.

The faceplate 278b and/or the jack housing 278a provide a supporting structure that may be integral sensing assembly, providing structural support and protection for the internal components and/or alignment of components, such as alignment of the jack 276 and/or the fiber 277 with the passive-sensing detector plug assembly 279′. Proper alignment of one or more of the components may be important to ensure proper functionality of the passive-sensing detector plug assembly 279′. The design of the passive-sensing fiberoptic termination assembly 275′ ensures durability and facilitates integration into customer premises, enabling secure installation and reliable operation. In at least some embodiments, the faceplate 278b can be mounted on the front of jack housing 278a and includes an aperture for accommodating the passive-sensing detector plug assembly 279′. The faceplate 278 enhances the protection and aesthetic integration of the sensing assembly while supporting secure connections with external devices.

The jack 276 can be positioned within jack housing 278a and serves as an interface for the fiber 277. At least a portion of the fiber 277 can be routed through at least a portion of the jack 276 to provide a fiber termination that exposes an end of the fiber 277. The passive-sensing detector plug assembly 279′, when engaged within the jack 276 through a plug accepting aperture 284 (FIG. 2K) of the faceplate 278b directs the fiberoptic transmission signal towards the screen 281. The screen 281 can be sized, shaped and/or otherwise configured to prevent hazardous exposure to laser radiation emanating from the exposed end of the fiber 277 and/or the unterminated jack 276. Alternatively, or in addition, the screen 281 can be configured as a sensor to provide a visual indication responsive to laser radiation emanating from the exposed end of the fiber 277 when properly aligned with the fiber 277 and/or the jack 276 during the example engaged configuration. It is understood that in at least some embodiments, the screen 281 can be configured according to the illustrative examples provided herein as a passive sensor, e.g., including a material that emits visible radiation responsive to excitation by the laser radiation, which may be invisible. In at least some embodiments, the passive-sensing detector plug assembly 279′ includes a beam spreader 282 for subsequent dispersion of the laser radiation to expand the radiation to intersect a larger region of the screen 281 than would otherwise be intersected by an unspread beam. This alignment is necessary to ensure the proper operation of the sensing assembly.

The passive-sensing detector plug assembly 279′ is operatively coupled to the sensing assembly and interacts with plug housing 280. The passive-sensing detector plug assembly 279′ enables controlled engagement and disengagement with the jack 276, contributing to the versatility and precision of the sensing mechanism. The screen 281 can be positioned adjacent to spreader 282 and is coated with photosensitive material, such that the screen undergoes visible changes in response to the absorption of light from the fiber 277 and/or the jack 276 providing a visual indication of the physical properties of the fiberoptic transmission signal, such as an intensity or wavelength of the fiberoptic transmission signal. The spreader 282 can be located between the exposed fiber end of fiber 277 and the screen 281, such that the spreader 282 disperses the fiberoptic transmission signal over a predetermined area of the screen 281, ensuring uniform interaction with the photosensitive material for accurate detection and visualization of the signal's properties.

In at least some embodiments, a shroud 283 (shown in phantom) can be positioned around at least a portion of the screen 281. The shroud 283 may prevent dust, debris, and other contaminants from interfering with the functionality of the passive-sensing detector plug assembly 279′, thereby enhancing the durability and operational lifespan of the assembly. Alternatively, or in addition, the shroud 283 may shadow at least a portion of the screen 281 from ambient light to facilitate interpretation of any visual indications, e.g., emitted photons at visible wavelengths as may be provided by the screen 281. The shroud 283 may be formed integrally to the faceplate 278b, the plug housing 280 or a combination thereof. Alternatively, or in addition, at least a portion of the shroud 283 may be provided as a separate item, e.g., a paper or cardboard shroud 283 as may be provided with network equipment and/or subscription paperwork for temporary usage, e.g., during installation.

FIG. 2K is a block diagram illustrating yet another example, non-limiting embodiment of a passive, optical sensing, fiber termination assembly 275″, shown in a disengaged configuration and functioning within the optical distribution network 200 of FIG. 2A and the communication system 100 of FIG. 1 in accordance with various aspects described herein. In a disengaged configuration, the detector plug assembly 279″ is separated from the jack 276, e.g., having no part crossing a plane of the faceplate 278b. Given that the passive-sensing detector plug assembly 279′ provides a safety function, it is envisioned that the passive-sensing detector plug assembly 279′ would remain in an engaged configuration unless another cable and/or device were coupled to the jack 276.

FIG. 2L is a block diagram illustrating another example, non-limiting embodiment of an optical distribution network 287 adapted for passively sensing optical signals at a fiber termination and functioning within the communication system 100 of FIG. 1 in accordance with various aspects described herein. The example optical distribution network 287 includes a central office (CO) 285, a Passive Optical Networks (PON) 289 and customer premises 290. The CO 285 includes an Optical Line Terminal (OLT) 286a, one or more items of optical test equipment 286b and an optical coupling device 286c. According to the illustrative example, the optical coupling device 286c enables both the OLT 286a and the optical test equipment 286b to be coupled to the PON 289. With this configuration, testing of the optical distribution network 287 and/or components connected thereto, may be performed without necessarily interfering with other PON activity. For example, testing of a particular PON branch, such as a branch terminating at the example customer premises 290 may be performed without disturbing network services of other customer premises (not shown).

An OLT 286a is a critical component in a PON 289, located at the service provider's CO 285. It serves as the endpoint of the optical fiber network on the provider's side and manages the transmission of data to and from multiple Optical Network Terminals (ONTs) or Optical Network Units (ONUs) at customer premises 290. The OLT 286a converts electrical signals into optical signals for downstream transmission and optical signals back into electrical signals for upstream reception. It also performs key network management functions, such as bandwidth allocation, traffic scheduling, and signal distribution, ensuring efficient and reliable communication across the network. Additionally, the OLT 286a supports multiple PON standards, such as GPON (Gigabit Passive Optical Network) and EPON (Ethernet Passive Optical Network), and is designed to handle high-speed data, voice, and video services. By enabling point-to-multipoint communication, the OLT 286a reduces infrastructure costs while maintaining high performance, making it an essential element in modern fiber optic communication systems.

The optical coupling device 286c is a device used in fiber optic systems to split or combine optical signals. The optical coupling device 286c enables a distribution of light signals between multiple fibers or channels. By way of nonlimiting example, the optical coupling device 286c may include an optical coupler or splitter, e.g., a 1×2 splitter to split one optical input signal into two output signals, such as an uplink signal directed from the customer premises 290 to both the OLT 286a and the optical test equipment 286b. The example 1×2 splitter may also combine two optical signals into one combined signal, e.g., combining a downlink signal from the OLT 286a with a test signal originating at the optical test equipment 286b to obtain a combined optical signal directed towards the customer premises 290. Other combinations of optical signals may include, generally, 1×N and/or M×N splitter/combiners. Still other examples of optical coupling devices 286c can include wavelength division multiplexors configured to combine and/or separate optical signals based on their wavelengths, and/or directional couplers that split and/or combine signals based on their direction of propagation, star couplers, tapered fiber couplers and/or hybrid couplers.

The optical test equipment may include an optical source, e.g., a laser and/or an LED, an optical detector, e.g., a photodiode, an optical power meter, a spectrometer, and/or an optical time domain reflectometer (OTDR), to name some examples.

The ONT and/or residential gateway 297 a device used in fiber optic communication systems to serve as the endpoint of a Passive Optical Network (PON) at the customer premises, which may be further connected to other equipment at the customer premises 290, e.g., including end user equipment 294, such as a computer, a smart television, a home automation device, and so on. The ONT is responsible for converting optical signals received from the Optical Line Terminal (OLT) at the service provider's central office into electrical signals that can be used by customer devices, such as routers, computers, and telephones. It also converts electrical signals from customer devices into optical signals for upstream transmission to the OLT.

According to the example optical distribution network 287, there are multiple PON drops or demarcation points at the customer premises 290, with each PON drop terminating in a respective one of the example protective fiber jacks 291 a through 291f, generally 291. An inset illustrates one of the example protective fiber jacks 291d′ as including a protective shield 295 and a visual indicator 296. The protective shield 295 can be configured to prevent laser light hazards by blocking, reflecting and/or otherwise attenuating a laser light signal from an active PON network 289 when the protective fiber jack 291d′ is without any interconnecting cable and/or device. Likewise, the visual indicator 296 can provide a visible indication to a nearby observer related to at least one physical property of laser light as may be present when connected to an active PON network 289.

The visual indicator 296 can provide feedback to ensure proper signal transmission and/or reception. For example, a mere presence of the visible indication may indicate a presence of laser light. Alternatively, or in addition, the visible indication may contain emitted light that may vary in one or more of intensity, shape, position and/or color. It is understood that of the light may provide an indication that a quality of the visible indication, e.g., an intensity, shape, position and/or color may indicate one or more physical properties of the laser light, such as its intensity and/or wavelength content. It is further understood that in at least some embodiments, the visual indication may facilitate testing and/or diagnostics of the optical signals to ensure proper functionality and performance.

For new service, customer self-installation, the customer connects the ONT/RG 297′ to a previously installed fiber jack 291d′ with a supplied fiber cable. In at least some embodiments, the ONT/RG 297′ supplied by the service provider can be configured to initiate a self-provisioning process upon attachment to the fiber jack 291d′. If the process fails, or after it completes, but service does not appear to be available, the customer may choose to contact the service provider's helpdesk. In such instances, a customer may be asked to remove the fiber cable from the previously installed fiber jack 291d′. The customer may be asked next to look at the fiber jack 291d′ to see if there is a color, a shade, a symbol or some other visible indication 296 on the fiber jack 291d′, e.g., on the fiber screen, shutter or visual indicator 296, to indicate if there is optical transmission signal present. If there is no signal present a dispatch for a technician may be sent. However, if there is a signal, tech support can determine depending upon whether the signal indication indicates whether a low, medium, or high signal is present, and/or perhaps whether some particular wavelength or combination of wavelength bands are present as may be indicated by the visual indication. For example, based on a visual indication of a low level, a technician may be dispatch or troubleshooting may continue with the customer to isolate faulty equipment and/or equipment that may have been wrongly connected. The above process can also apply if existing service failed to determine if it is local to the equipment or in the fiber route between providers CO 285 and the customer premises 290.

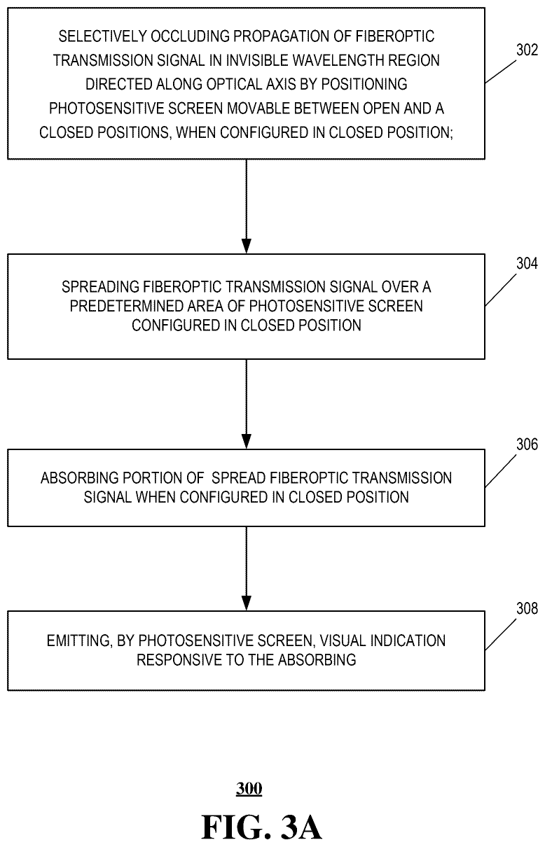

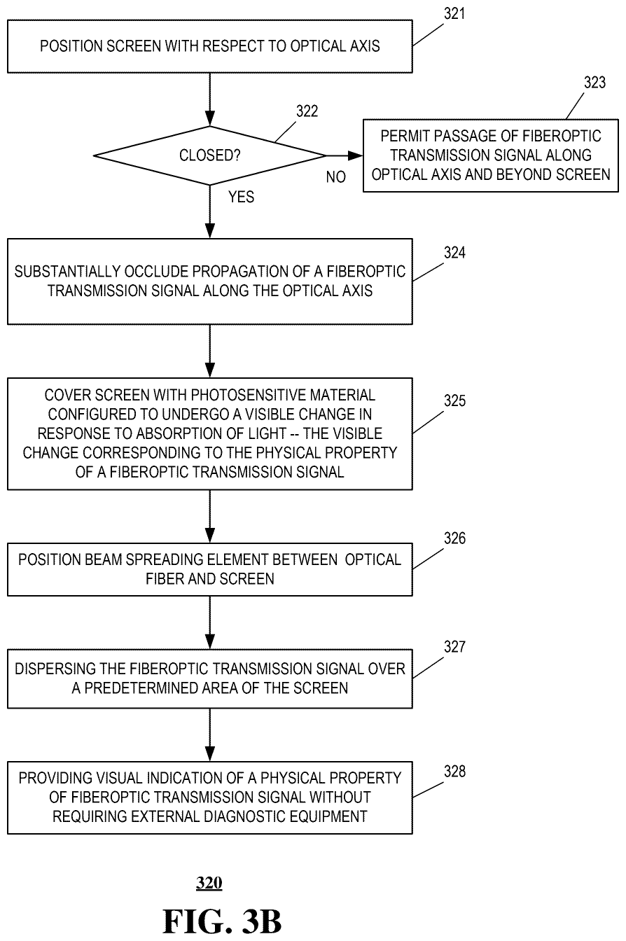

FIG. 3A depicts an illustrative embodiment of a process 300 adapted for passively sensing optical signals at a fiber termination in accordance with various aspects described herein. FIG. 3A shows an embodiment of a process 300 for passively sensing a fiberoptic signal. The process 300 can be implemented to visually detect physical properties of fiberoptic transmission signals without requiring external diagnostic equipment. The example process 300 involves selectively occluding signal propagation at 302, spreading the signal over a photosensitive screen at 304, absorbing the signal at 306, and emitting a visual indication corresponding to the absorbed signal at 308.

According to the illustrative example, the process 300 selectively occludes at 302 propagation of a fiberoptic transmission signal residing within an invisible wavelength region directed along an optical axis. This can be achieved by positioning a screen, e.g., a photosensitive screen, movable between an open position and a closed position, wherein the screen, when configured in the closed position, substantially blocks the signal's propagation along the optical axis.

At step 304, the process 300 spreads the fiberoptic transmission signal over a predetermined area of the photosensitive screen configured in the closed position 302. This spreading is facilitated by a beam spreading element, which ensures that the signal is evenly distributed across the screen, enabling uniform interaction with the photosensitive material.

At step 306, the process 300 absorbs a portion of the spread fiberoptic transmission signal residing within the invisible wavelength region when the screen is configured in the closed position. The photosensitive material on the screen captures the signal, allowing for the detection of the physical properties of the signal, such as intensity or wavelength.

At step 308, the process 300 emits a visual indication responsive to the absorption of the fiberoptic transmission signal. The photosensitive screen undergoes a visible change, such as displaying varying shades or colors, corresponding to the physical properties of the signal, thereby providing a clear visual representation without the need for external diagnostic equipment.

FIG. 3B depicts another illustrative embodiment of a process 320 adapted for passively sensing optical signals at a fiber termination in accordance with various aspects described herein. The example process 320 is designed to visually detect physical properties of fiberoptic transmission signals without requiring external diagnostic equipment. The steps of the process 320 include positioning a screen at 321, occluding a fiberoptic transmission signal at 322, spreading the fiberoptic transmission signal at 327, and visually indicating the fiberoptic signal's properties at 328.

In more detail, and at step 321, the process 320 positions a screen with respect to an optical axis. This positioning ensures that the screen is aligned to interact with the fiberoptic transmission signal, enabling subsequent steps of the method to be carried out effectively.

At step 322, the process 320 determines whether the screen is in a closed position. If the screen is not closed, the method proceeds to step 323, where the fiberoptic transmission signal is permitted to pass along the optical axis and beyond the screen. If the screen is closed, the method advances to step 324.

At step 324, the process 320 substantially occludes the propagation of the fiberoptic transmission signal along the optical axis. This occlusion is achieved by the screen in the closed position, effectively blocking the signal's passage and preparing the signal for interaction with the photosensitive material at 325.

At step 325, the process 320 covers the screen with a photosensitive material configured to undergo a visible change in response to the absorption of light. This visible change corresponds to a physical property of the fiberoptic transmission signal, such as intensity or wavelength, enabling visual detection of the signal's characteristics.

At step 326, the process 320 positions a beam spreading element at 326 between the optical fiber and the screen. The beam spreading element ensures that the fiberoptic transmission signal 323 is appropriately dispersed before interacting with the photosensitive material on the screen.

At step 327, the process 320 disperses the fiberoptic transmission signal over a predetermined area of the screen. This dispersion ensures uniform interaction between the signal and the photosensitive material, facilitating accurate detection of the signal's physical properties.

At step 328, the process 320 provides a visual indication of a physical property of the fiberoptic transmission signal. This visual indication is achieved without requiring external diagnostic equipment, making the method suitable for customer self-installation and troubleshooting scenarios.

While for purposes of simplicity of explanation, the respective processes are shown and described as a series of blocks in FIGS. 3A and 3B, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

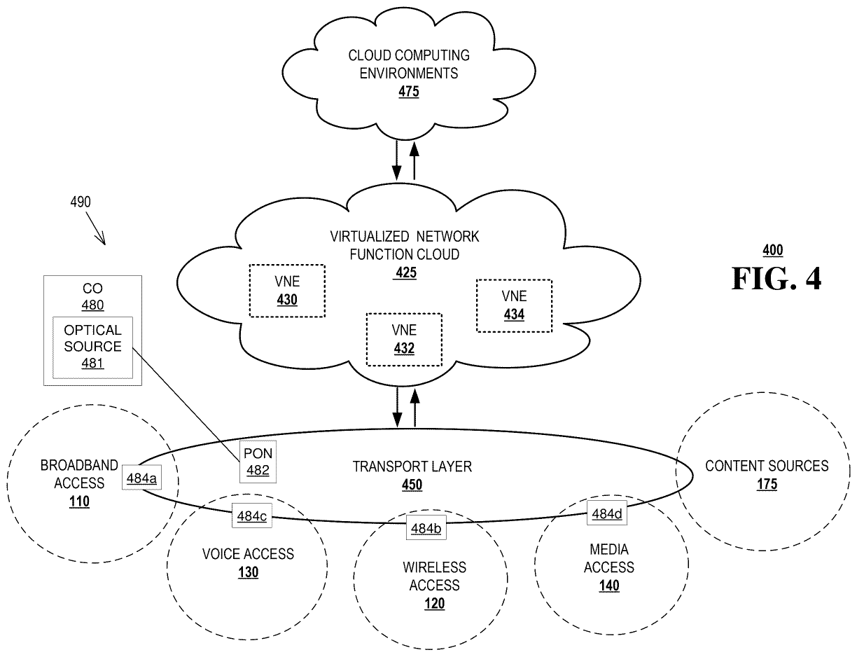

Referring now to FIG. 4, a block diagram is shown illustrating an example, non-limiting embodiment of a virtualized communication network 400 in accordance with various aspects described herein. In particular a virtualized communication network is presented that can be used to implement some or all of the subsystems and functions of the communication system 100, the subsystems and functions of systems 200, 220, 220′, 225, 235, 240, 245, 250, 265, 275′, 275″, 287 and processes 300 and 320 presented in FIGS. 1, 2A, 2B, 2C, 2D, 2E, 2F, 2G, 2H, 2I, 2J, 2K, 2L, 3A and 3B. For example, virtualized communication network 400 can facilitate in whole or in part a passive fiberoptic signal sensing device and methods that use a photosensitive material to visually indicate the presence, intensity, and/or wavelength of optical signals, enabling efficient troubleshooting and customer self-installation of broadband services, while also offering protection from exposure to fiberoptic transmission signals.

In particular, a cloud networking architecture is shown that leverages cloud technologies and supports rapid innovation and scalability via a transport layer 450, a virtualized network function cloud 425 and/or one or more cloud computing environments 475. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements-which are typically integrated to perform a single function, the virtualized communication network employs virtual network elements (VNEs) 430, 432, 434, etc., that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 430 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 450 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 430, 432 or 434. These network elements can be included in transport layer 450.

The virtualized network function cloud 425 interfaces with the transport layer 450 to provide the VNEs 430, 432, 434, etc., to provide specific NFVs. In particular, the virtualized network function cloud 425 leverages cloud operations, applications, and architectures to support networking workloads. The virtualized network elements 430, 432 and 434 can employ network function software that provides either a one-for-one mapping of traditional network element function or alternately some combination of network functions designed for cloud computing. For example, VNEs 430, 432 and 434 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers-each of which adds a portion of the capability, and which creates an elastic function with higher availability overall than its former monolithic version. These virtual network elements 430, 432, 434, etc., can be instantiated and managed using an orchestration approach similar to those used in cloud compute services.

The cloud computing environments 475 can interface with the virtualized network function cloud 425 via APIs that expose functional capabilities of the VNEs 430, 432, 434, etc., to provide the flexible and expanded capabilities to the virtualized network function cloud 425. In particular, network workloads may have applications distributed across the virtualized network function cloud 425 and cloud computing environment 475 and in the commercial cloud or might simply orchestrate workloads supported entirely in NFV infrastructure from these third-party locations.

In at least some embodiments, the communication system 400 includes an optical distribution network 490, e.g., extending from a central office (CO) 480 to customer premises served by one or more of the various access networks 110, 120, 130, 140. For example, the CO 480 may contain an optical source, such as an example optical line terminal (OLT) 481. The OLT 481 can be coupled to demarcation terminals at customer premises served by one or more of the various access networks 110, 120, 130, 140, such as the example fiber jacks 484a through 484d, generally 484. In at least some embodiments, a passive optical network (PON) provides optical channels, e.g., optical fibers, couplers, splitters and so on, to optically couple the fiber jacks 484 to the OLT 481, e.g., to permit connection of an ONU and/or an ONT to the OLT 481 via the PON.

The fiber jacks 484 can be configured with shields that block and/or otherwise occlude any laser light carried by the PON 482 from existing the fiber jacks 484, especially when the fiber jacks 484 are disconnected from any cabling and/or devices. According to the illustrative embodiments presented herein, the fiber jacks 484 and/or the provided shields provided thereon, may be configured to provide a visual indication responsive to presence of laser light as may be delivered by the PON 482. It is understood that circumstances may result in an unintended interruption to delivery of PON service to a particular fiber jack 484 as may result from a broken cable, and/or a disconnection somewhere within the PON 482 and/or within local fiber routing within the customer premises. Beneficially, the visual indication may be used by an end user or consumer to identify whether optical signal is present at a particular jack 484 without requiring special test equipment and/or without requiring local assistance of a trained technician. For example, the end user may relay a visual indication status to a helpdesk and/or self-help program to facilitate diagnostic procedures to detect, locate and/or remedy any defects.

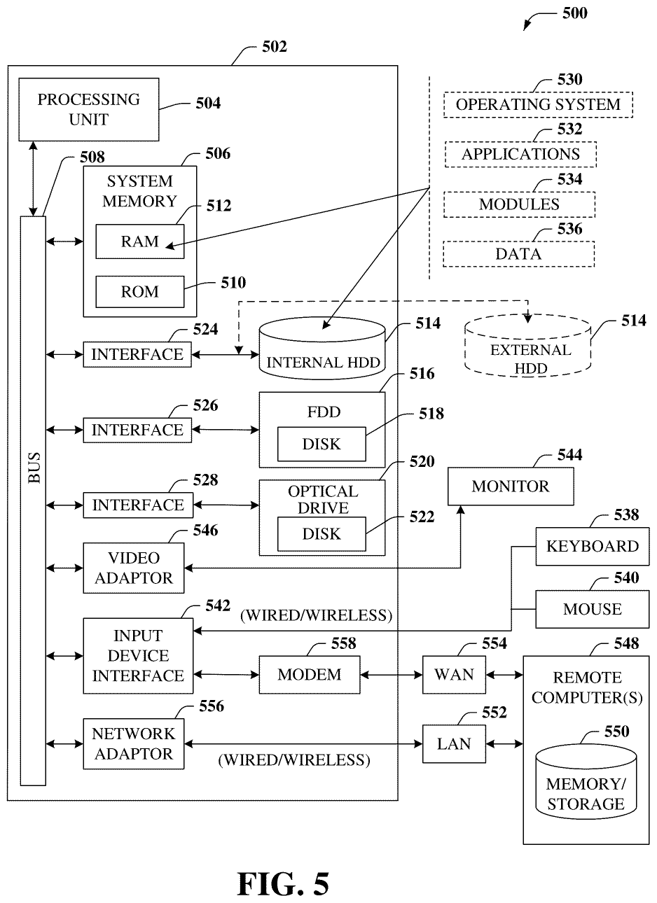

Turning now to FIG. 5, there is illustrated a block diagram of a computing environment in accordance with various aspects described herein. In order to provide additional context for various embodiments of the embodiments described herein, FIG. 5 and the following discussion are intended to provide a brief, general description of a suitable computing environment 500 in which the various embodiments of the subject disclosure can be implemented. In particular, computing environment 500 can be used in the implementation of network elements 150, 152, 154, 156, access terminal 112, base station or access point 122, switching device 132, media terminal 142, and/or VNEs 430, 432, 434, etc. Each of these devices can be implemented via computer-executable instructions that can run on one or more computers, and/or in combination with other program modules and/or as a combination of hardware and software. For example, computing environment 500 can facilitate in whole or in part a passive fiberoptic signal sensing device and methods that use a photosensitive material to visually indicate the presence, intensity, and/or wavelength of optical signals, enabling efficient troubleshooting and customer self-installation of broadband services, while also offering protection from exposure to fiberoptic transmission signals.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 5, the example environment can comprise a computer 502, the computer 502 comprising a processing unit 504, a system memory 506 and a system bus 508. The system bus 508 couples system components including, but not limited to, the system memory 506 to the processing unit 504. The processing unit 504 can be any of various commercially available processors. Dual microprocessors and other multiprocessor architectures can also be employed as the processing unit 504.

The system bus 508 can be any of several types of bus structure that can further interconnect to a memory bus (with or without a memory controller), a peripheral bus, and a local bus using any of a variety of commercially available bus architectures. The system memory 506 comprises ROM 510 and RAM 512. A basic input/output system (BIOS) can be stored in a non-volatile memory such as ROM, erasable programmable read only memory (EPROM), EEPROM, which BIOS contains the basic routines that help to transfer information between elements within the computer 502, such as during startup. The RAM 512 can also comprise a high-speed RAM such as static RAM for caching data.

The computer 502 further comprises an internal hard disk drive (HDD) 514 (e.g., EIDE, SATA), which internal HDD 514 can also be configured for external use in a suitable chassis (not shown), a magnetic floppy disk drive (FDD) 516, (e.g., to read from or write to a removable diskette 518) and an optical disk drive 520, (e.g., reading a CD-ROM disk 522 or, to read from or write to other high-capacity optical media such as the DVD). The HDD 514, magnetic FDD 516 and optical disk drive 520 can be connected to the system bus 508 by a hard disk drive interface 524, a magnetic disk drive interface 526 and an optical drive interface 528, respectively. The hard disk drive interface 524 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 502, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 512, comprising an operating system 530, one or more application programs 532, other program modules 534 and program data 536. All or portions of the operating system, applications, modules, and/or data can also be cached in the RAM 512. The systems and methods described herein can be implemented utilizing various commercially available operating systems or combinations of operating systems.

A user can enter commands and information into the computer 502 through one or more wired/wireless input devices, e.g., a keyboard 538 and a pointing device, such as a mouse 540. Other input devices (not shown) can comprise a microphone, an infrared (IR) remote control, a joystick, a game pad, a stylus pen, touch screen or the like. These and other input devices are often connected to the processing unit 504 through an input device interface 542 that can be coupled to the system bus 508, but can be connected by other interfaces, such as a parallel port, an IEEE 1394 serial port, a game port, a universal serial bus (USB) port, an IR interface, etc.

A monitor 544 or other type of display device can be also connected to the system bus 508 via an interface, such as a video adapter 546. It will also be appreciated that in alternative embodiments, a monitor 544 can also be any display device (e.g., another computer having a display, a smart phone, a tablet computer, etc.) for receiving display information associated with computer 502 via any communication means, including via the Internet and cloud-based networks. In addition to the monitor 544, a computer typically comprises other peripheral output devices (not shown), such as speakers, printers, etc.

The computer 502 can operate in a networked environment using logical connections via wired and/or wireless communications to one or more remote computers, such as a remote computer(s) 548. The remote computer(s) 548 can be a workstation, a server computer, a router, a personal computer, portable computer, microprocessor-based entertainment appliance, a peer device or other common network node, and typically comprises many or all of the elements described relative to the computer 502, although, for purposes of brevity, only a remote memory/storage device 550 is illustrated. The logical connections depicted comprise wired/wireless connectivity to a local area network (LAN) 552 and/or larger networks, e.g., a wide area network (WAN) 554. Such LAN and WAN networking environments are commonplace in offices and companies, and facilitate enterprise-wide computer networks, such as intranets, all of which can connect to a global communications network, e.g., the Internet.

When used in a LAN networking environment, the computer 502 can be connected to the LAN 552 through a wired and/or wireless communication network interface or adapter 556. The adapter 556 can facilitate wired or wireless communication to the LAN 552, which can also comprise a wireless AP disposed thereon for communicating with the adapter 556.

When used in a WAN networking environment, the computer 502 can comprise a modem 558 or can be connected to a communications server on the WAN 554 or has other means for establishing communications over the WAN 554, such as by way of the Internet. The modem 558, which can be internal or external and a wired or wireless device, can be connected to the system bus 508 via the input device interface 542. In a networked environment, program modules depicted relative to the computer 502 or portions thereof can be stored in the remote memory/storage device 550. It will be appreciated that the network connections shown are example and other means of establishing a communications link between the computers can be used.

The computer 502 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

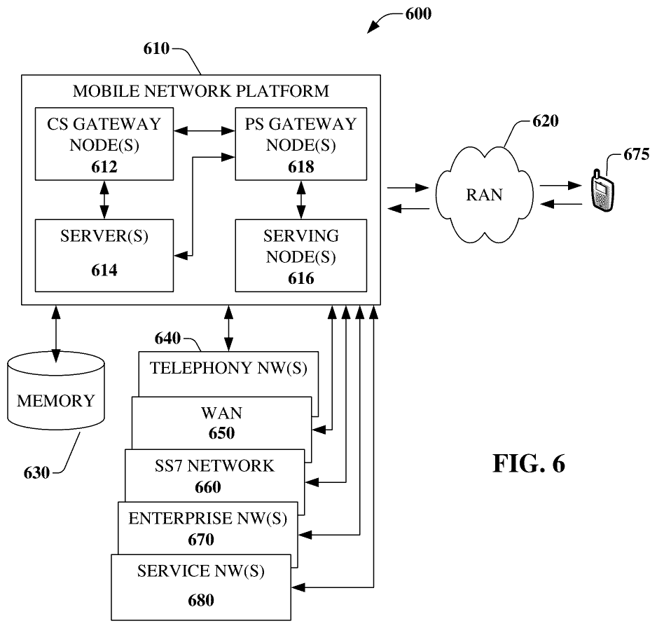

Turning now to FIG. 6, an embodiment 600 of a mobile network platform 610 is shown that is an example of network elements 150, 152, 154, 156, and/or VNEs 330, 332, 334, etc. For example, platform 610 can facilitate in whole or in part a passive fiberoptic signal sensing device and methods that use a photosensitive material to visually indicate the presence, intensity, and/or wavelength of optical signals, enabling efficient troubleshooting and customer self-installation of broadband services, while also offering protection from exposure to fiberoptic transmission signals. In one or more embodiments, the mobile network platform 610 can generate and receive signals transmitted and received by base stations or access points such as base station or access point 122. Generally, mobile network platform 610 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 610 can be included in telecommunications carrier networks and can be considered carrier-side components as discussed elsewhere herein. Mobile network platform 610 comprises CS gateway node(s) 612 which can interface CS traffic received from legacy networks like telephony network(s) 640 (e.g., public switched telephone network (PSTN), or public land mobile network (PLMN)) or a signaling system #7 (SS7) network 660. CS gateway node(s) 612 can authorize and authenticate traffic (e.g., voice) arising from such networks. Additionally, CS gateway node(s) 612 can access mobility, or roaming, data generated through SS7 network 660; for instance, mobility data stored in a visited location register (VLR), which can reside in memory 630. Moreover, CS gateway node(s) 612 interfaces CS-based traffic and signaling and PS gateway node(s) 618. As an example, in a 3GPP UMTS network, CS gateway node(s) 612 can be realized at least in part in gateway GPRS support node(s) (GGSN). It should be appreciated that functionality and specific operation of CS gateway node(s) 612, PS gateway node(s) 618, and serving node(s) 616, is provided and dictated by radio technology(ies) utilized by mobile network platform 610 for telecommunication over a radio access network 620 with other devices, such as a radiotelephone 675.

In addition to receiving and processing CS-switched traffic and signaling, PS gateway node(s) 618 can authorize and authenticate PS-based data sessions with served mobile devices. Data sessions can comprise traffic, or content(s), exchanged with networks external to the mobile network platform 610, like wide area network(s) (WANs) 650, enterprise network(s) 670, and service network(s) 680, which can be embodied in local area network(s) (LANs), can also be interfaced with mobile network platform 610 through PS gateway node(s) 618. It is to be noted that WANs 650 and enterprise network(s) 670 can embody, at least in part, a service network(s) like IP multimedia subsystem (IMS). Based on radio technology layer(s) available in technology resource(s) or radio access network 620, PS gateway node(s) 618 can generate packet data protocol contexts when a data session is established; other data structures that facilitate routing of packetized data also can be generated. To that end, in an aspect, PS gateway node(s) 618 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 600, mobile network platform 610 also comprises serving node(s) 616 that, based upon available radio technology layer(s) within technology resource(s) in the radio access network 620, convey the various packetized flows of data streams received through PS gateway node(s) 618. It is to be noted that for technology resource(s) that rely primarily on CS communication, server node(s) can deliver traffic without reliance on PS gateway node(s) 618; for example, server node(s) can embody at least in part a mobile switching center. As an example, in a 3GPP UMTS network, serving node(s) 616 can be embodied in serving GPRS support node(s) (SGSN).

For radio technologies that exploit packetized communication, server(s) 614 in mobile network platform 610 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 610. Data streams (e.g., content(s) that are part of a voice call or data session) can be conveyed to PS gateway node(s) 618 for authorization/authentication and initiation of a data session, and to serving node(s) 616 for communication thereafter. In addition to application server, server(s) 614 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 610 to ensure network's operation and data integrity in addition to authorization and authentication procedures that CS gateway node(s) 612 and PS gateway node(s) 618 can enact. Moreover, provisioning server(s) can provision services from external network(s) like networks operated by a disparate service provider; for instance, WAN 650 or Global Positioning System (GPS) network(s) (not shown). Provisioning server(s) can also provision coverage through networks associated to mobile network platform 610 (e.g., deployed and operated by the same service provider), such as the distributed antennas networks shown in FIG. 1(s) that enhance wireless service coverage by providing more network coverage.

It is to be noted that server(s) 614 can comprise one or more processors configured to confer at least in part the functionality of mobile network platform 610. To that end, the one or more processors can execute code instructions stored in memory 630, for example. It should be appreciated that server(s) 614 can comprise a content manager, which operates in substantially the same manner as described hereinbefore.

In example embodiment 600, memory 630 can store information related to operation of mobile network platform 610. Other operational information can comprise provisioning information of mobile devices served through mobile network platform 610, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 630 can also store information from at least one of telephony network(s) 640, WAN 650, SS7 network 660, or enterprise network(s) 670. In an aspect, memory 630 can be, for example, accessed as part of a data store component or as a remotely connected memory store.

In order to provide a context for the various aspects of the disclosed subject matter, FIG. 6, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc., that perform particular tasks and/or implement particular abstract data types.

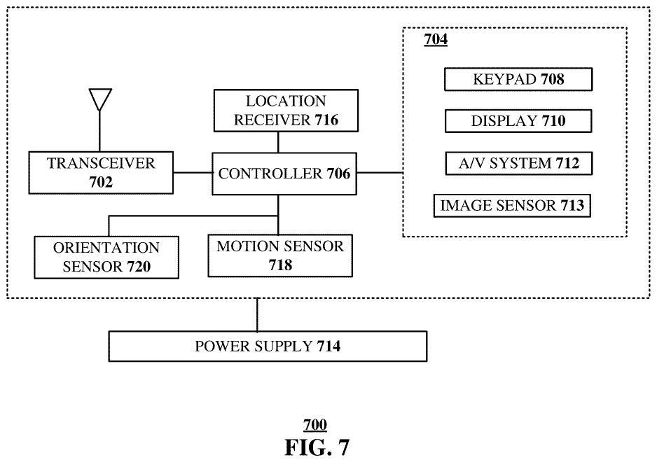

Turning now to FIG. 7, an illustrative embodiment of a communication device 700 is shown. The communication device 700 can serve as an illustrative embodiment of devices such as data terminals 114, mobile devices 124, vehicle 126, display devices 144 or other client devices for communication via either communications network 125. For example, computing device 700 can facilitate in whole or in part a passive fiberoptic signal sensing device and methods that use a photosensitive material to visually indicate the presence, intensity, and/or wavelength of optical signals, enabling efficient troubleshooting and customer self-installation of broadband services, while also offering protection from exposure to fiberoptic transmission signals.

The communication device 700 can comprise a wireline and/or wireless transceiver 702 (herein transceiver 702), a user interface (UI) 704, a power supply 714, a location receiver 716, a motion sensor 718, an orientation sensor 720, and a controller 706 for managing operations thereof. The transceiver 702 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 702 can also be adapted to support circuit-switched wireline access technologies (such as PSTN), packet-switched wireline access technologies (such as TCP/IP, VoIP, etc.), and combinations thereof.

The UI 704 can include a depressible or touch-sensitive keypad 708 with a navigation mechanism such as a roller ball, a joystick, a mouse, or a navigation disk for manipulating operations of the communication device 700. The keypad 708 can be an integral part of a housing assembly of the communication device 700 or an independent device operably coupled thereto by a tethered wireline interface (such as a USB cable) or a wireless interface supporting for example Bluetooth®. The keypad 708 can represent a numeric keypad commonly used by phones, and/or a QWERTY keypad with alphanumeric keys. The UI 704 can further include a display 710 such as monochrome or color LCD (Liquid Crystal Display), OLED (Organic Light Emitting Diode) or other suitable display technology for conveying images to an end user of the communication device 700. In an embodiment where the display 710 is touch-sensitive, a portion or all of the keypad 708 can be presented by way of the display 710 with navigation features.

The display 710 can use touch screen technology to also serve as a user interface for detecting user input. As a touch screen display, the communication device 700 can be adapted to present a user interface having graphical user interface (GUI) elements that can be selected by a user with a touch of a finger. The display 710 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 710 can be an integral part of the housing assembly of the communication device 700 or an independent device communicatively coupled thereto by a tethered wireline interface (such as a cable) or a wireless interface.

The UI 704 can also include an audio system 712 that utilizes audio technology for conveying low volume audio (such as audio heard in proximity of a human ear) and high-volume audio (such as speakerphone for hands free operation). The audio system 712 can further include a microphone for receiving audible signals of an end user. The audio system 712 can also be used for voice recognition applications. The UI 704 can further include an image sensor 713 such as a charged coupled device (CCD) camera for capturing still or moving images.

The power supply 714 can utilize common power management technologies such as replaceable and rechargeable batteries, supply regulation technologies, and/or charging system technologies for supplying energy to the components of the communication device 700 to facilitate long-range or short-range portable communications. Alternatively, or in combination, the charging system can utilize external power sources such as DC power supplied over a physical interface such as a USB port or other suitable tethering technologies.

The location receiver 716 can utilize location technology such as a global positioning system (GPS) receiver capable of assisted GPS for identifying a location of the communication device 700 based on signals generated by a constellation of GPS satellites, which can be used for facilitating location services such as navigation. The motion sensor 718 can utilize motion sensing technology such as an accelerometer, a gyroscope, or other suitable motion sensing technology to detect motion of the communication device 700 in three-dimensional space. The orientation sensor 720 can utilize orientation sensing technology such as a magnetometer to detect the orientation of the communication device 700 (north, south, west, and east, as well as combined orientations in degrees, minutes, or other suitable orientation metrics).

The communication device 700 can use the transceiver 702 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 706 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 700.

Other components not shown in FIG. 7 can be used in one or more embodiments of the subject disclosure. For instance, the communication device 700 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or non-volatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x₁, x₂, x₃, x₄ . . . xₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or.” That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to,” “coupled to,” and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A passive, fiberoptic signal sensing device, comprising:
a housing; and
an integrated optical sensing assembly disposed within the housing, the optical sensing assembly comprising:
a photosensitive screen comprising a photosensitive material configured to undergo a visible change in response to absorption of light, the visible change corresponding to a physical property of a fiberoptic transmission signal; and
a beam spreading element operatively coupled to the photosensitive screen and configured for dispersing the fiberoptic transmission signal over a predetermined area thereof, wherein the photosensitive screen provides a visual indication of the physical property of the fiberoptic transmission signal without requiring external diagnostic equipment.

2. The passive, fiberoptic signal sensing device of claim 1, wherein the photosensitive material is configured to detect at least one of an ultraviolet wavelength, a visible, near-infrared wavelength, or a mid-infrared wavelength.

3. The passive, fiberoptic signal sensing device of claim 1, wherein the physical property of the fiberoptic transmission signal comprises intensity, and wherein the photosensitive material is configured to display different shades based on the intensity of the fiberoptic transmission signal.

4. The passive, fiberoptic signal sensing device of claim 1, wherein the physical property of the fiberoptic transmission signal comprises wavelength, and wherein the photosensitive screen is configured to display different colors based on the wavelength of the fiberoptic transmission signal.

5. The passive, fiberoptic signal sensing device of claim 1, wherein the beam spreading element is a lens or a diffuser designed to substantially evenly distribute a substantial portion of the fiberoptic transmission signal over the predetermined area of the photosensitive screen.

6. The passive, fiberoptic signal sensing device of claim 1, wherein the photosensitive screen further comprises a protective cover to substantially prevent transmission of the fiberoptic transmission signal therethrough.

7. The passive, fiberoptic signal sensing device of claim 1, wherein the housing is configured to be installed in a wall jack for customer self-installation of broadband services.

8. The passive, fiberoptic signal sensing device of claim 1, wherein the photosensitive screen includes a symbol responsive to a reaction of the photosensitive material to the fiberoptic transmission signal, wherein the symbol provides a visual indication of the physical property.

9. The passive, fiberoptic signal sensing device of claim 8, wherein the symbol comprises a plurality of stripes visually responsive to different wavelengths of the fiberoptic transmission signal, wherein different stripes of the plurality of stripes respond to respective wavelengths of the fiberoptic transmission signal.

10. The passive, fiberoptic signal sensing device of claim 8, wherein the photosensitive material includes a slow-fading material to maintain the visual indication for a predetermined period after the fiberoptic transmission signal is removed.

11. The passive, fiberoptic signal sensing device of claim 1, wherein the integrated optical sensing assembly is configured to provide a visual indication of signal presence and intensity for troubleshooting purposes, reducing a need for technician visits.

12. A method for passively sensing a fiberoptic signal, comprising:
positioning a screen is operable between an open position and a closed position relative to an optical axis, wherein the screen configured in the closed position substantially occludes propagation of a fiberoptic transmission signal along the optical axis;
covering at least a portion of the screen with a photosensitive material configured to undergo a visible change in response to absorption of light, the visible change corresponding to a physical property of a fiberoptic transmission signal; and
positioning a beam spreading element between one end of an optical fiber aligned with the optical axis, wherein the beam spreading element is configured for dispersing the fiberoptic transmission signal over a predetermined area of the screen, wherein the screen provides a visual indication of a physical property of the fiberoptic transmission signal without requiring external diagnostic equipment.

13. The method for passively sensing a fiberoptic signal of claim 12, wherein the physical property comprises intensity, and wherein undergoing the visible change further comprises displaying different shades based on the intensity of the fiberoptic transmission signal.

14. The method for passively sensing a fiberoptic signal of claim 12, wherein the physical property of the fiberoptic transmission signal comprises wavelength, and wherein undergoing the visible change further comprises displaying different colors based on the wavelength of the fiberoptic transmission signal.

15. The method for passively sensing a fiberoptic signal of claim 12, wherein the dispersing the fiberoptic transmission signal over the predetermined area of the screen comprises at least one of refracting or diffusing the fiberoptic transmission signal over the predetermined area of the screen.

16. The method for passively sensing a fiberoptic signal of claim 12, wherein the positioning the screen comprises positioning the screen to cover a receptacle of a wall jack configured for customer self-installation of broadband services.

17. The method for passively sensing a fiberoptic signal of claim 12, wherein undergoing the visible change further comprises providing a symbolic representation of the physical property of the fiberoptic transmission signal.

18. The method for passively sensing a fiberoptic signal of claim 17, wherein the symbolic representation of the physical property further comprises a plurality of stripes visually responsive to different wavelengths of the fiberoptic transmission signal, and wherein different stripes of the plurality of stripes respond to respective wavelengths of the fiberoptic transmission signal.

19. The method for passively sensing a fiberoptic signal of claim 12, wherein the visible change of the photosensitive material in response to absorption of light comprises:
absorbing a portion of the fiberoptic transmission signal residing in an invisible portion of the electromagnetic spectrum, wherein the visible change further comprises emitting light within a visible portion of the electromagnetic spectrum.

20. A method for passively sensing a fiberoptic signal, comprising:
selectively occluding propagation of a fiberoptic transmission signal residing within an invisible wavelength region directed along an optical axis by positioning a photosensitive screen movable between an open position and a closed position configured in the closed position;
spreading the fiberoptic transmission signal to obtain a spread fiberoptic transmission signal extending over a predetermined area of the photosensitive screen configured in the closed position,
absorbing, by the photosensitive screen, at least a portion of the spread fiberoptic transmission signal residing within the invisible wavelength region when configured in the closed position; and
emitting, by the photosensitive screen, a visual indication responsive to the absorbing the at least the portion of the spread fiberoptic transmission signal residing within the invisible wavelength region.
